(19) United States
(12) Patent Application Publication
(10) Pub. No.: US 2005/0246221 A1
(43) Pub. Date: Nov. 3, 2005

(54) Automated system and method for determination and reporting of business development opportunities

(76) Inventors: William F. Geritz III, Columbia, MD (US); Paul Navarro, Baltimore, MD (US); Patricia Ann Ourednik, Bel Air, MD (US); Donald P. Mahoney, Cochranville, PA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/057,417

(22) Filed: Feb. 14, 2005

Related U.S. Application Data
(60) Provisional application No. 60/544,555, filed on Feb. 13, 2004.

(51) Int. Cl. G06F 17/60

(52) U.S. Cl. 705/10

(57) ABSTRACT

A method and system for allowing providers of goods and services in an environment of a specific population of prospective business partners (e.g., a tradeshow environment) to determine the existence of and track connections between and among one another, and for allowing an administrator of such environment in which such connections may take place to likewise track such connections.

### CROSS REFERENCE TO RELATED APPLICATION

This application is based upon and claims benefit of copending and co-owned U.S. Provisional Patent Application Serial No. 60/544,555 entitled “Automated System and Method for Determination and Reporting of Business Development Opportunities,” filed with the U.S. Patent and Trademark Office on Feb. 13, 2004 by the inventors herein, the specification of which is incorporated herein by reference.

### BACKGROUND OF THE INVENTION

1. Field of the Invention

The invention disclosed herein relates generally to an automated method and system for the determination and reporting of business development opportunities, and more particularly to an automated method and system for allowing providers of goods and services in an environment of a specific population of prospective business partners to determine the existence of and track connections between and among one another, and for allowing an administrator of the environment in which such connections may take place to likewise track such connections.

2. Background of the Prior Art

Persons involved in the development or marketing of new products or services, whether from the engineering, financial, or general management perspectives, are all faced with the challenge of finding the best available market opportunity for such newly developed products or services. At times, one company may have lofty goals of deploying a new product or service but may lack the technical expertise to bring such product or service to market. Other times, a company may have developed a new technology that it believes is valuable but for which there is an undefined or underdeveloped commercial market. Obviously, many other barriers likewise exist to the introduction of new products or services into the marketplace and the realization of commercial success.

In order to address these challenges, many persons and/or companies involved in the development and/or marketing of new products or services will seek out partners to address certain of the challenges associated with introducing a new product or service to the commercial marketplace. For instance, they may wish to simply establish a network of persons in particular industries apart from their own who would be able to advise them of the potential applications or acceptance of the new product or service in their respective industries. Alternately, the developer of the new technology may wish to establish such a network of persons in varying industries in order to determine how the new product or service might be combined or integrated with products or services in such industries to provide a new product or service offering combining the two.

In order to establish these networks of persons having such expertise, or even to establish networks of potential buyers for one's own products and services, many developers and marketers of new products or services undertake “networking” efforts, i.e., attending trade shows, scientific conferences, professional association meetings, and the like in order to establish relationships with as wide a variety of persons as possible. This common strategy relies on the hope that establishing a wide network will eventually, on a somewhat haphazard basis, allow the networking person to establish a relationship with someone who is in a position to effect the course of action of a potential purchaser, seller, technology partner, or other business partner with regard to that networking person's own products, services, or other business needs. While such random contacts may, assuming a wide enough networking effort, lead to some success in establishing relationships with those persons in other organizations effecting such organizations' courses of action, it remains a highly inefficient means to build relationships that would lead to lasting, mutually beneficial business relationships.

Efforts have been made in the past to create electronic networking environments in which individuals may register with an online service (such as providing their email address and other contact information) in an online but nonetheless haphazard attempt to find some chain of contacts that they might be able to exploit in order to personally contact a specific individual. For example, U.S. Pat. No. 6,175,831 to Weinreich et al. describes a networking database containing multiple user records which indicate defined personal relationships among users, such that one user may potential follow a series of such relationships from himself to another user with whom they would like to establish contact. While such online “social networking” services are gaining in popularity, they still rely on the randomness of beneficial relationships being overcome by the numbers of persons involved in the service. In other words, if the services are successful at registering a large number of diverse users, the probability increases that a business development executive will be able to find a chain of contacts to a specific person at a specific company whom they would like to meet or talk with in order to explore a potential business relationship. However, such tools still require that the user know who it is that they are looking for, and thus does little for the business development executive who is looking for all potential contacts with whom he or she should seek a relationship in order to advance the commercial exploitation of their new product or service.

It would therefore be helpful to provide an automated system for creating contacts that goes beyond the simple identification of routes to particular persons a user might want to contact, but that in fact finds specific persons that, from a business development perspective, the user should want to contact, regardless of whether the user knows that such person exists. It would further be helpful to provide an automated system that, in addition to identifying persons a user should want to contact from a business development perspective, also provides the user with an indication for why that person would be an appropriate contact, i.e., the extent to which such person or persons are likely to provide the user with a business development opportunity, whether in the context of a product purchase, product sale, new product development, joint venture, merger or acquisition, or the like. It would also be helpful to provide to such administrators of programs (e.g., tradeshows) in which such potential contacts could be sought to have a mechanism by which they could track the success of such programs in establishing such contacts, and to extend prospective participants' involvement in such program to in turn increase their interest in the program (and thus there purchases of registrations in the program).

### SUMMARY OF THE INVENTION

The present invention comprises an automated method and system for the determination and reporting of business development opportunities, and more particularly to an automated method and system for allowing providers of goods and services in an environment of a specific population of prospective business partners to determine the existence of and track connections between and among one another, and for allowing an administrator of the environment in which such connections may take place to likewise track such connections.

In a first aspect of a preferred embodiment of the invention, the method and system provide an environment in which a provider of goods or services may identify qualified business partners among a population of prospective business partners by searching demographic data and behaviors of such prospective business partners, classifying the results of such search based on the user's own criteria for identifying qualified business partners, and enabling communication among such user and the qualified business partners. A related aspect also provides an automated environment in which an administrator of a program structured to bring together such user and prospective business partners may track connections made between and among them, and likewise extend each such prospective business partner's participation in the program, thus increasing interest and growing income through increased registrations in such program.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows is a schematic diagram of an exemplary lead generation and tracking system according to a preferred embodiment of the invention.

FIG. 2 is an exemplary data input screen for receiving company information according to a preferred embodiment of the invention.

FIG. 3 is an exemplary Product Categories selection screen according to a preferred embodiment of the invention.

FIG. 4 is an exemplary Product Listing data input screen according to a preferred embodiment of the invention.

FIG. 4a is an exemplary Add/Edit Product data input screen according to a preferred embodiment of the invention.

FIG. 4b is a top level view of an exemplary Market Space Definition Taxonomy according to a preferred embodiment of the invention.

FIG. 5 is an exemplary Contact Information data input screen according to a preferred embodiment of the invention.

FIG. 6 is an exemplary My Expertise selection screen according to a preferred embodiment of the invention.

FIG. 7 is an exemplary My Product Interests selection screen according to a preferred embodiment of the invention.

FIG. 8 is an exemplary Leads Profile summary screen according to a preferred embodiment of the invention.

FIG. 8a is an exemplary Keywords and Phrases display and input screen according to a preferred embodiment of the invention.

FIG. 8b is an exemplary Product Categories selection screen according to a preferred embodiment of the invention.

FIG. 9 is a chart detailing scoring for user behaviors and demographics according to a preferred embodiment of the invention.

FIG. 10 is a chart summarizing behavior and demographic scoring according to a preferred embodiment of the invention.

FIG. 11 is a flowchart reflecting screening of User Profiles to generate leads according to a preferred embodiment of the invention.

FIG. 12 is an exemplary Connection Details summary screen according to a preferred embodiment of the invention.

FIG. 13 is an exemplary Pending Connections listing screen according to a preferred embodiment of the invention.

FIG. 14 is an exemplary Established Connections listing screen according to a preferred embodiment of the invention.

FIG. 15 is an exemplary Schedule a Meeting data input screen according to a preferred embodiment of the invention.

FIG. 16 is an exemplary Meeting Calendar display screen according to a preferred embodiment of the invention.

FIG. 17 is an exemplary Booth Visits display screen according to a preferred embodiment of the invention.

FIG. 18 is an exemplary Search data input screen according to a preferred embodiment of the invention.

FIG. 19 is an exemplary Saved Searches display screen according to a preferred embodiment of the invention.

FIG. 19a is an exemplary Search Results display screen according to a preferred embodiment of the invention.

FIG. 19b is an exemplary Results Detail display screen according to a preferred embodiment of the invention.

FIG. 20 is an exemplary Find Peers and Colleagues data input screen according to a preferred embodiment of the invention.

FIG. 21 is an exemplary Find People data input screen according to a preferred embodiment of the invention.

FIG. 22 is an exemplary People Search Results display screen according to a preferred embodiment of the invention.

FIG. 23 is an exemplary Connection Details / Invite Connection display screen according to a preferred embodiment of the invention.

FIG. 24 is an exemplary Connection Request Details data input screen according to a preferred embodiment of the invention.

FIG. 25 is an exemplary Connection Details/Accept Connection display screen according to a preferred embodiment of the invention.

FIG. 26 is an exemplary Find Products and Companies selection screen according to a preferred embodiment of the invention.

FIG. 27 is an exemplary Find Sessions search screen according to a preferred embodiment of the invention.

FIG. 28 is a flow chart showing communications from the system to users during the lead conversion process according to a preferred embodiment of the invention.

FIG. 29 is an exemplary Exhibitor Opportunity Report according to a preferred embodiment of the invention.

FIG. 30 is an exemplary You-Based Event Report according to a preferred embodiment of the invention.

FIG. 31 is an exemplary Exhibitor Activity Report according to a preferred embodiment of the invention.

FIG. 32 is an exemplary Justification Report according to a preferred embodiment of the invention.

FIG. 33 is an exemplary Owner Analytics Report according to a preferred embodiment of the invention.

### DETAILED DESCRIPTION OF THE PREFERRED EMBODIMENTS OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

A method and system are provided for enabling product or service providers an environment in which they may identify and be notified of the existence of individuals with whom such provider might wish to enter into a business transaction, and for enabling a program administrator (e.g., an entity desiring to produce a tradeshow) to track the interactions among product or service providers registered for such program. In a particularly preferred embodiment, such product or service provider may be an exhibitor or an attendee at a trade show, exhibition, or other environment in which the provider may have access to a large population of would-be business partners, whether those partners represent potential purchasers of the entity's particular goods or services, technology partners with or from whom the entity might wish to provide or receive other technology, manufacturing partners with whom the entity might wish to enter into an OEM agreement, or other partners who might be suitable for a wide variety of business transactions. In order to give such providers the maximum opportunity to explore relationships with potential business partners, it is necessary to both identify those partners and provide a mechanism by which the interactions with those potential partners may be tracked so that leads may be followed up and pursued to their fullest opportunity. The method and system described herein provide an automated environment to allow the provider to perform these functions; i.e., identify would-be business partners among the specific audience population, communicate with those would-be business partners, and track the interactions with those partners to ensure that such leads produce the maximum benefit.

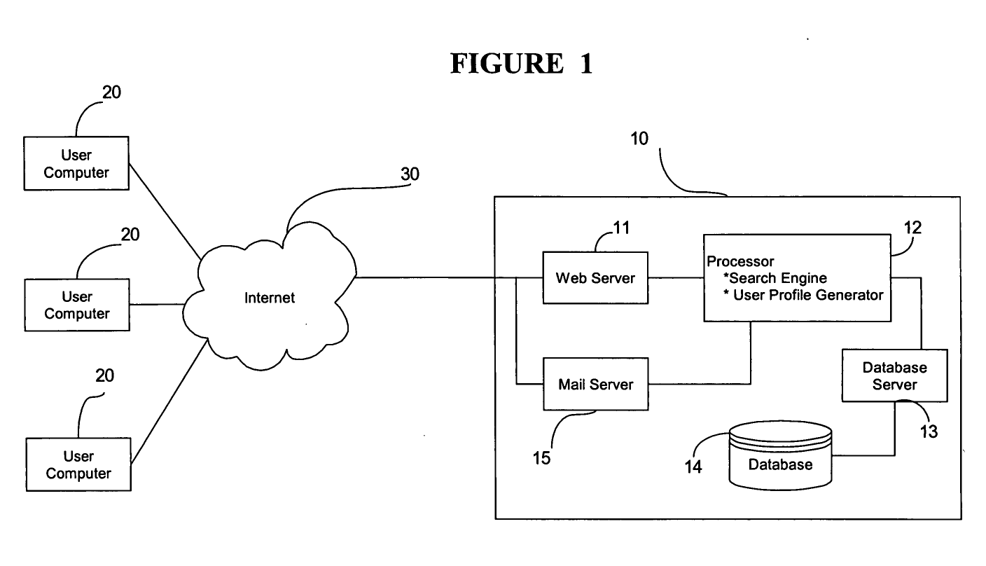

An exemplary system suitable for employing the lead generation and tracking environment is shown in FIG. 1. Such system preferably comprises a server system 10 accessible to a plurality of user computers 20 through a network 30, such as the Internet. User computers 20 are preferably personal computers having memory and communications software enabling communication through network 30 with remote server system 10 to exchange data with server system 10, such as through a web server 11 resident on or in communication with server system 10 capable of processing requests for documents and other services from user computers 20 and providing information over network 30 to such user computers 20. A processor 12 is provided in server system 10, which processor includes a search function capable of receiving search requests from users (as detailed below) and issuing such queries through a database server 13 to retrieve data from database 14. Web server 11 is also preferably capable of receiving data from user computers 20 and transmitting such data to processor 12 to create User Profiles (further detailed below) and, through database server 13, store such User Profiles in database 14. Database 14 preferably houses not only the User Profiles for the various users of the system, but also the knowledge bases used by the system in order to provide the rules and metrics by which leads may be identified.

As described below, each user of the system preferably engages the system to create a User Profile which identifies certain demographic characteristics about such user that in turn are used to determine potential matches with other users. While the specific data elements comprising the User Profile are described below, it is noted that such User Profile is unique to each user, and preferably comprises the complete data record for each such user to identify and track potential partners (i.e., “Leads”) for such user. The User Profile is preferably an electronic data record stored in one or more databases accessible to database server 13 so that such record may be readily retrieved, searched, and modified.

Creation of Entity Profile for Exhibitor and Attendee

In a preferred method of the invention, a product or service provider, or other person seeking to establish a relationship with a potential business partner, such as an exhibitor or an attendee at a trade show, accesses the server system 10 to create an entity profile. Web server 11 provides a user interface enabling the user to engage the server system 10 to create such entity profile. In addition to providing general biographical information, the user is prompted to provide information concerning the general categories to which the products or services they offer belong, specific details concerning one or more particular products or services offered, the user's personal information, the user's particular areas of expertise and connection interests, and the categories of products or services in which the user is interested.

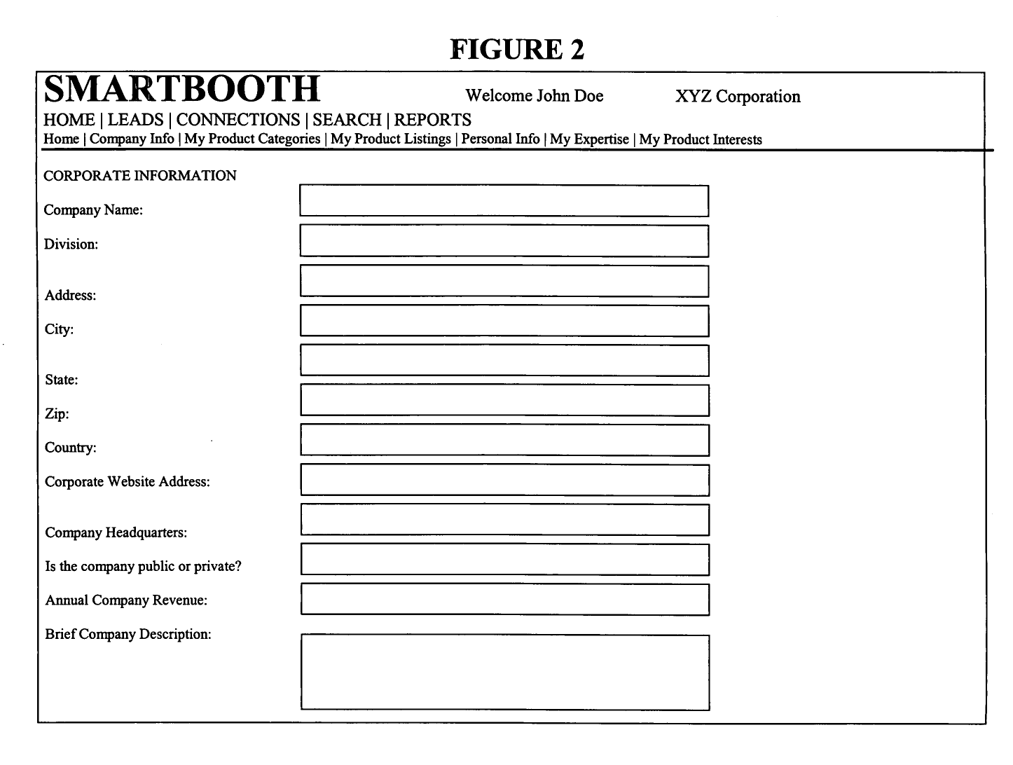

As shown on the exemplary Company Information screen of FIG. 2, the biographical information solicited from the user preferably comprises a series of data windows in which the user may input or select relevant biographical data, such as their company name and contact information, their company website, and the like.

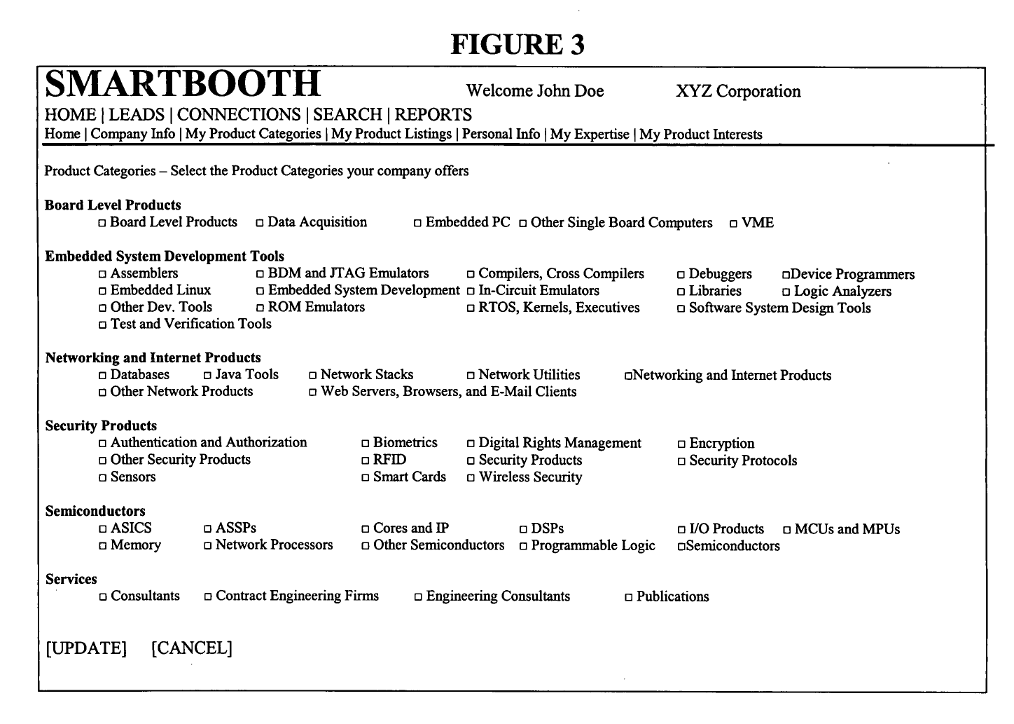

Following input of company information, as shown on FIG. 3, the user is prompted to provide information concerning the general categories to which their products or services belong. Preferably, the user is presented a list of different product or service categories allowing the user to select those categories relating to their own products or services. In a particularly preferred embodiment, the list of categories available for selection is particularly configured for the environment in which the system is to be used. For instance, if the system is intended for use by exhibitors and/or attendees at a trade show relating to systems design, as shown in the exemplary Product Category Selection Screen of FIG. 3, the categories may be separated into primary headings, such as “Board Level Products, Embedded System Development Tools,” etc., and further broken down into subheadings with more particularized product or service category titles. Once the user has selected those categories that relate to their own products or services, they may implement an “update” function to save such product category selections to their User Profile.

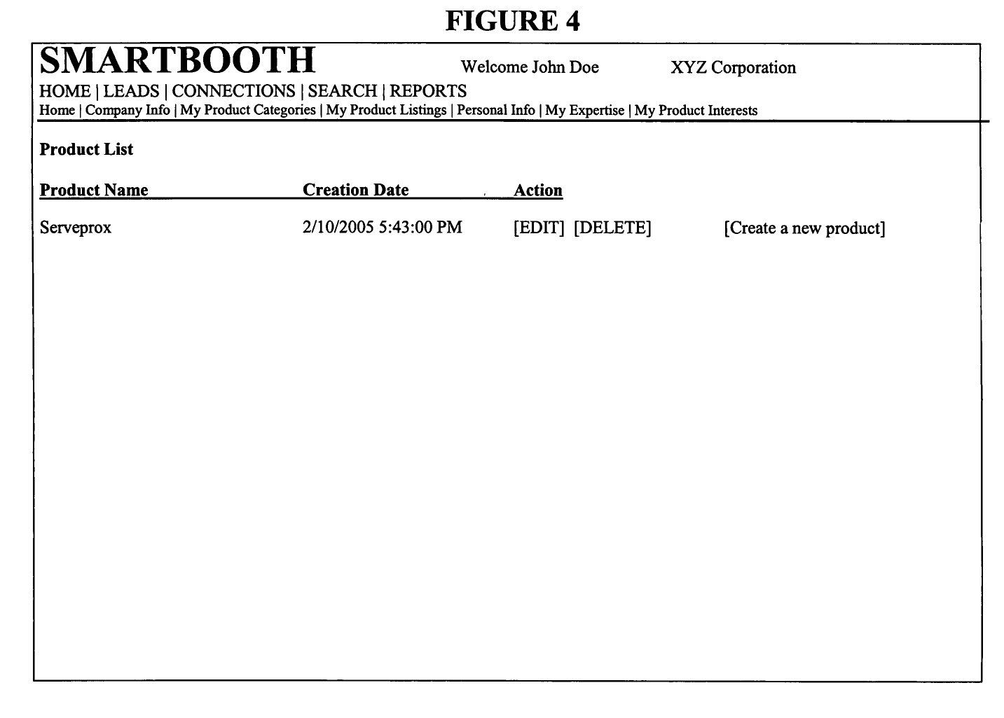

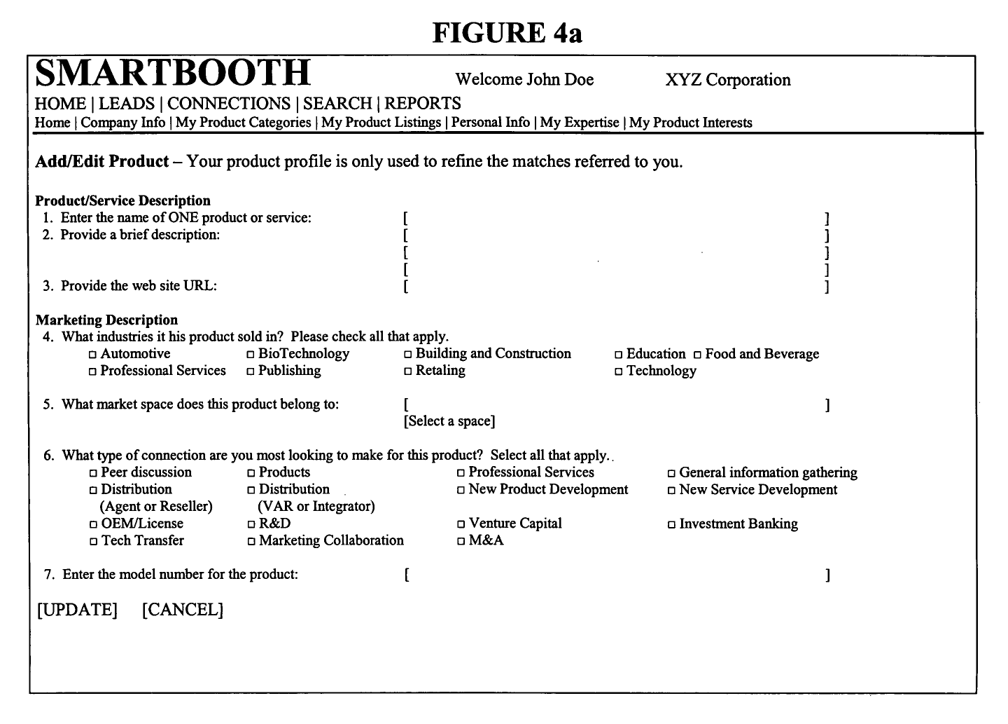

After selecting specific categories, as shown on FIG. 4, the user may create a list of specific products that they wish to particularly present to the population of potential business partners for consideration of a business relationship. Any products that the user has established are preferably displayed on the Product List Screen, an example of which is shown in FIG. 4. In order to create a new product or service to add to the Product List Screen, the user may implement a “create a new product” function that, in turn, presents the user with an “Add/Edit Product” screen as shown in FIG. 4a. The Add/Edit Product screen prompts a user to provide a profile for a particular product or service to enable the profile to be searched by the population of potential business partners. More particularly, the user is preferably prompted to input a product name, a textual description, and a website on which additional information for such product or service may be obtained. In addition to such general identifying information for the product or service, each product or service preferably also carries a Marketing Description, Market Space Definition, and Sales Description, all of which are selected by the user from lists of available market descriptions, market space definitions, and sales descriptions, respectively. More particularly, both Marketing Description and Sales Description classifications comprise check box selections allowing the user to designate those marketing descriptions and sales descriptions relevant to their product or service. Likewise, a pull down list allows a user to access a Market Space Definition Taxonomy, shown in greater detail in FIG. 4b. Preferably, such market space taxonomy is provided in the form of a multi-level outline structure, with each top level market space (particularly shown in FIG. 4b) potentially having subspaces and tertiary spaces there-under enabling fine selection of the relevant market space to which the particular product or service belongs. An exemplary automated market taxonomy suitable for use with the system and method set forth herein is described in co-owned U.S. patent application Publication No. US 2004/0243459, the specification of which is incorporated herein by reference. Once completed with the input of such selections, the user may implement an “update” function to save such selections to their User Profile. Also, it is of note that the particular categories defining the market description and sales description may be modified, including adding additional categories or removing categories from those listed, as is appropriate for the particular forum in which the method and system are to be used, without departing from the spirit and scope of the instant invention.

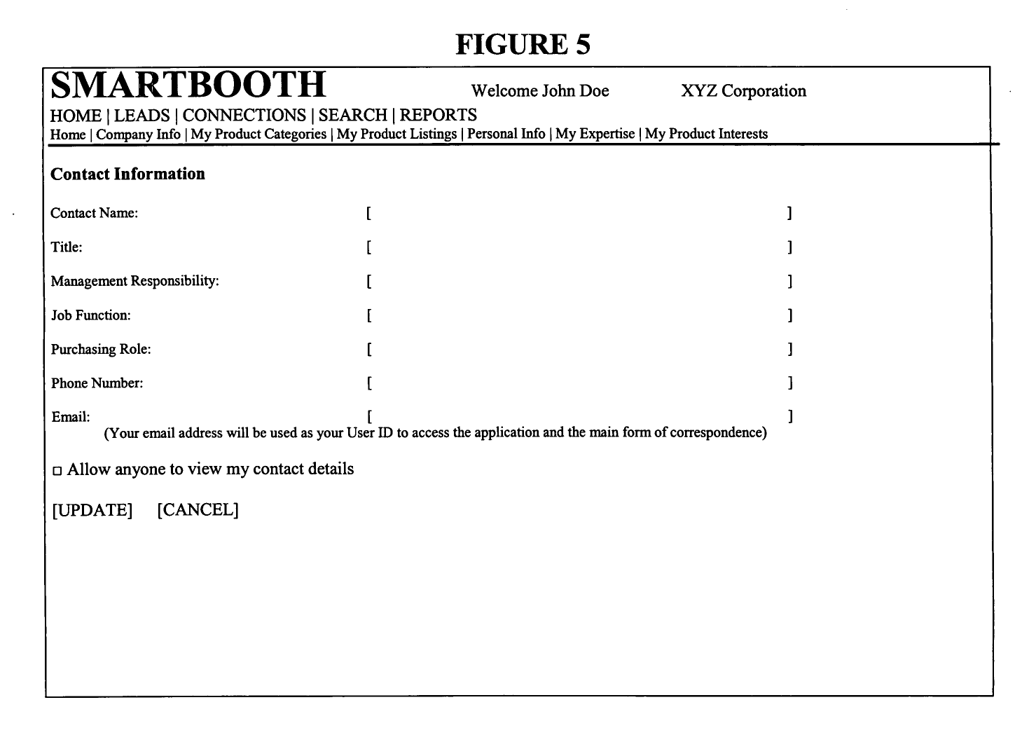

In addition to establishing a profile for the entity with which the particular user is associated, as shown in the exemplary Contact Information Screen of FIG. 5, that particular user is also preferably prompted to provide their own unique contact information, including their name, title, management responsibility, job function, purchasing role, and general contact information (such as telephone numbers and email addresses). When completed, the user preferably engages an update function to save their individual contact information to their User Profile.

It is noted that while multiple individual users may be associated with a single entity, each unique user is preferably provided their own identification key (i.e., User ID) to identify themselves and their individual User Profile to the system. The use of the information comprising each user's profile is set forth in greater detail below.

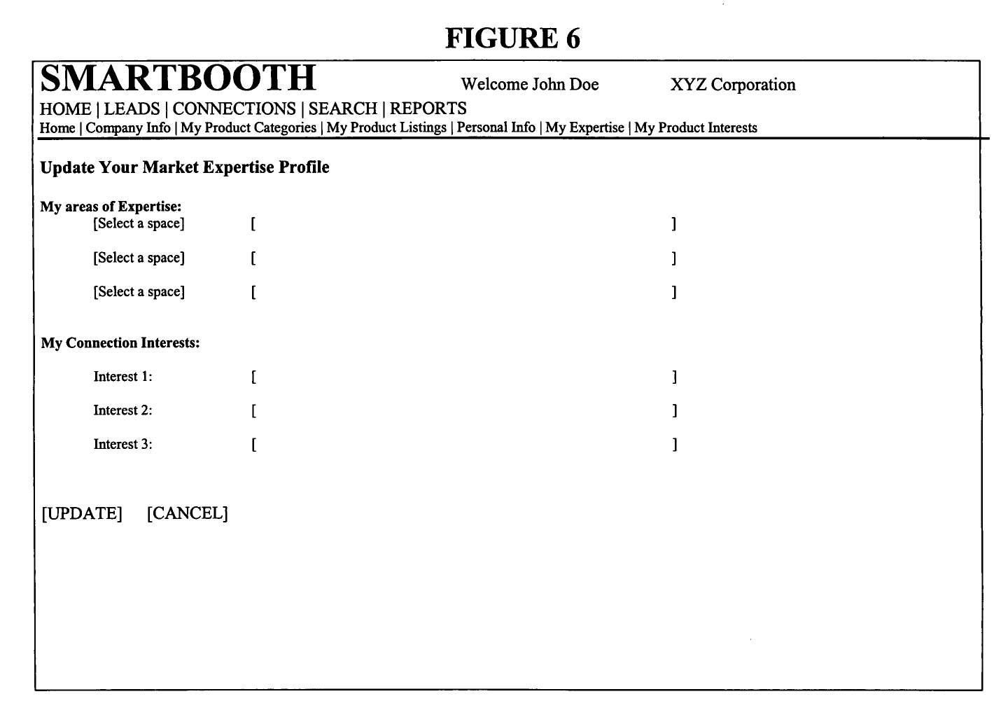

As shown in FIG. 6, another category of information solicited from the user is their individual Market Expertise Profile. When presented with a Market Expertise Profile screen, the user is prompted to select one or more areas in which that individual has expertise. Such selection is preferably made from the same market space taxonomy referenced above with regard to FIG. 4. Additionally, the user is prompted to indicate their “Connection Interests,” which interests may be selected from a pull-down list. The possible connection interests particularly identify potential reasons why the user might want to meet another member of the population, e.g., the particular type of transaction that might be explored if the user locates a suitable business partner. Such connection interests preferably include one or more of the following categories: Peer Discussion; Products; Professional Services; General Information Gathering; Distribution—Agent or Reseller; Distribution—VAR or Integrator; Technology (IP) Transfer; Marketing Collaboration; New Product Development; New Service Development; OEM/License; Research and Development; Venture Capital; Investment Banking; and M&A. Additional and/or alternate categories of potential business relationships, or other reasons why two members of the population might want to talk to one another, may be provided without departing from the spirit and scope of the invention. When completed, a user engages an update function to save their Market Expertise Profile to their User Profile.

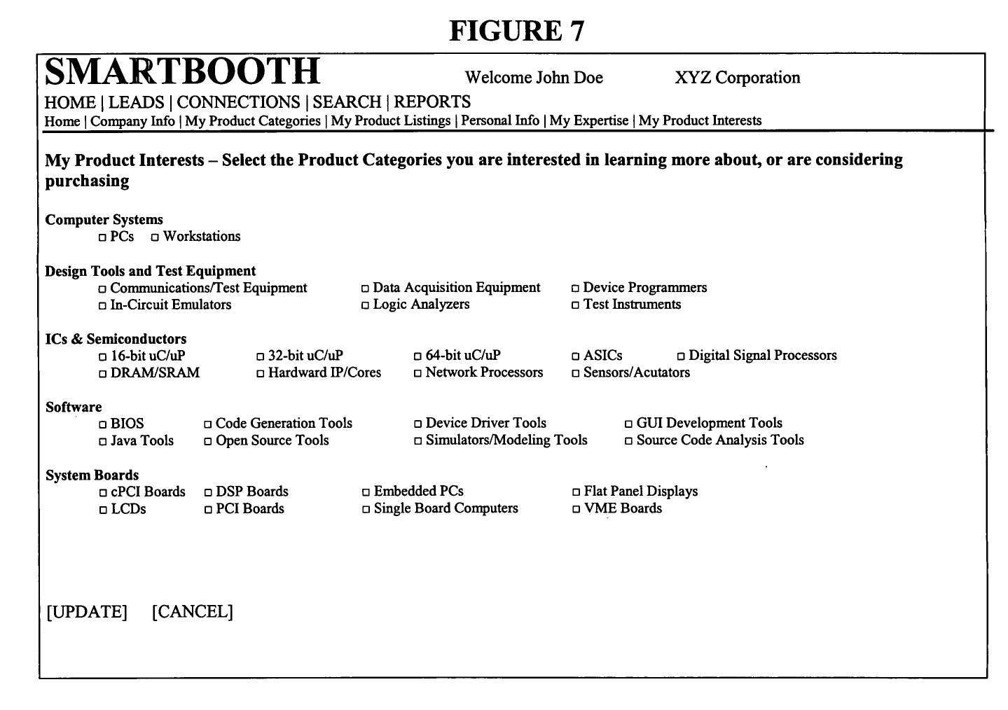

Another element of the User Profile is preferably solicited from the user, and is depicted in FIG. 7 as a Product Interests screen which allows the user to select specific product categories that such user might have interest in learning more about (such as for purposes of exploring a potential business relationship with a business partner, the subject matter of which concerns such product category), or which the user might have interest in purchasing from a prospective business partner. The particular product categories may be modified as necessary in order to have maximum applicability to the environment in which the system is to be used. Once the user has made their selections concerning their product interests, they may engage an update function to save their Product Interests to their User Profile.

Optionally, the system may provide different levels of access to different users, enabling some portion of the above-described editing capabilities to different users within a single company or other entity to enable only those individuals having sufficient or desired authority to change company data.

Searching and Lead Generation

Whether the user is an exhibitor or attendee at a tradeshow, or any other potential business partner in any forum, the user of the method and system herein will desire to identify and follow up with potential business partners in the relevant population. For those entities which might have a significant audience in the relevant population for their products or services, such as a trade show exhibitor, the method and system set forth herein provide a mechanism allowing the user to generate lists of potential business partner leads among the relevant population, and to track their interactions with one another.

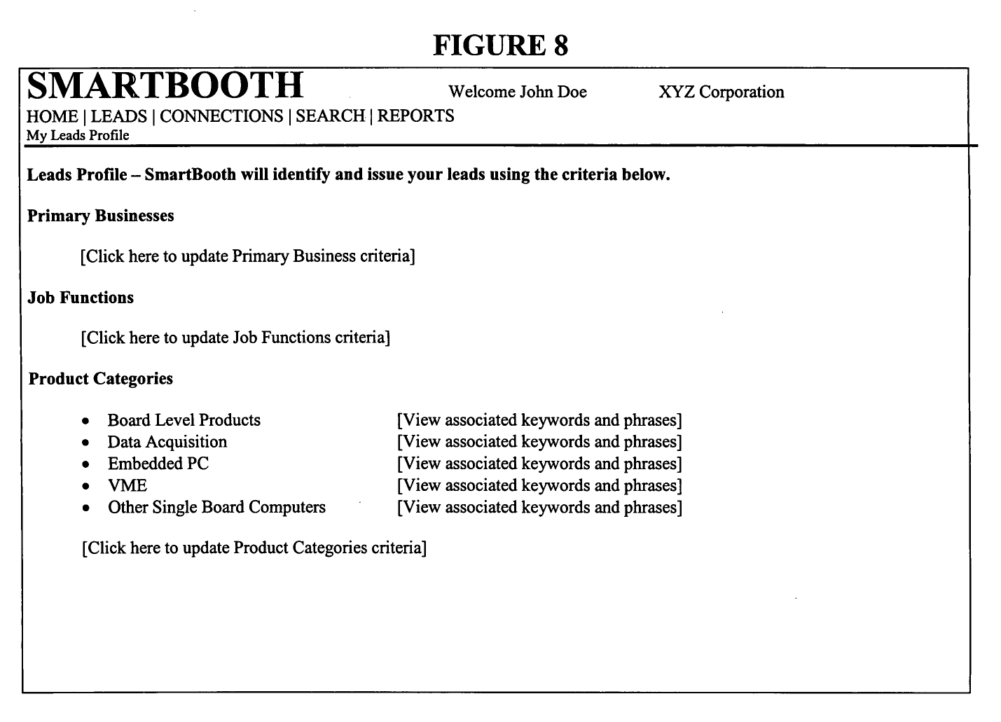

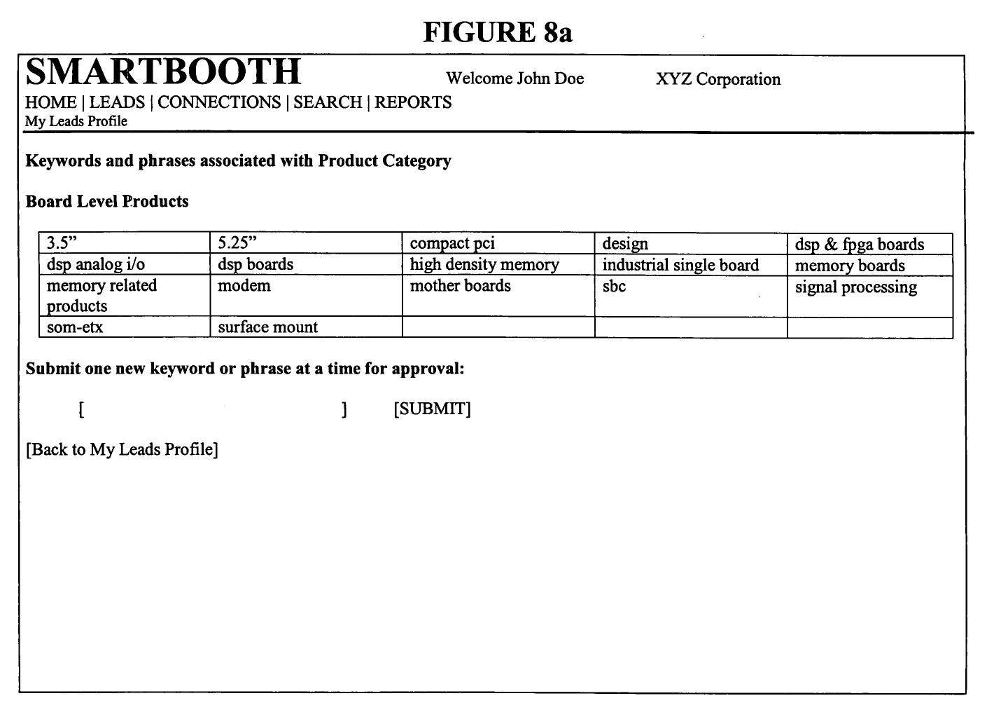

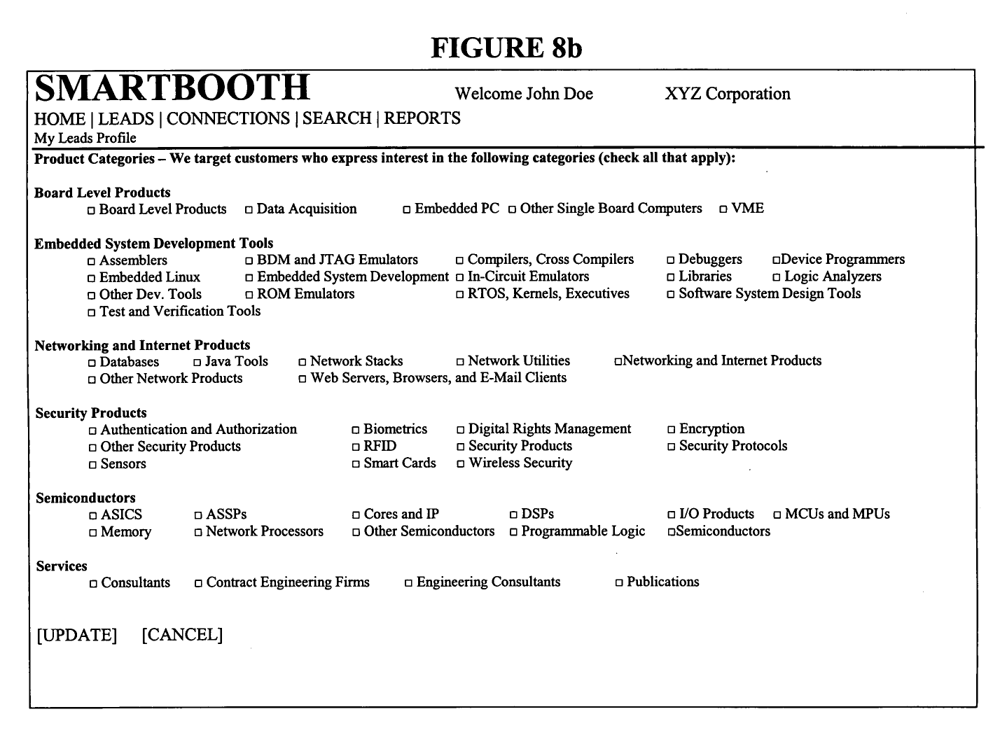

In order to select potential leads from among the relevant population, the user first preferably establishes their own Lead Profile. As shown in FIG. 8, the user is preferably presented a Leads Profile screen which allows the user to establish the criteria which the system will use to determine the set of leads from among the relevant population. The user's Lead Profile is preferably comprised of Primary Businesses which the user or the user's company targets for seeking business transactions, Job Functions which the user or the user's company targets for seeking business transactions, and Product Categories in which the user's or their company's targeted customers express interest. On the Leads Profile screen, the user may access an “update” function on each of those categories in order to select, deselect, or otherwise modify their selections. The specific categories of Primary Businesses, Job Functions, and Product Categories may be modified as appropriate for the specific forum in which the method and system are intended to be used, so long as they correspond to categories of businesses, categories of specific job functions, and categories of products and/or services, respectively.

Each of the Primary Business, Job Functions, and Product Categories may also have associated with their individual entries one or more keywords and/or phrases. As is discussed in greater detail below, such keywords and/or phrases may in turn be used during another user's search to identify the first user as a potential business partner.

In order to effect the lead generation and tracking functionalities, data from the user profiles of other members of the relevant population, and behaviors of such other members, are tracked, recorded, and associated with the entity to whom they relate according to a set of criteria accessible by the system. The system evaluates information in the user profile of each member of the relevant population, for instance, each attendee in a trade show environment, along with certain behaviors of each such member, against that set of criteria which in turn is used to determine a qualitative score for such member as a lead for the user. In a particularly preferred embodiment, the user may be an exhibitor at a trade show, and the members of the relevant population may be attendees, in which case the system evaluates such information from each attendee in order to determine a score for each such attendee as a lead for each exhibitor. The criteria used in order to evaluate the attendee data and behaviors is preferably maintained by an expert knowledge provider having administrative access to database 14 or other file containing the criteria so that such information may be updated, corrected, and otherwise maintained throughout the life of the system. The method and system will periodically automatically evaluate the relevant attendee user profile data and behaviors in order to establish matches and rankings for the attendees as leads for the various exhibitors. All attendees matching each exhibitor's lead criteria (as established by the system) are collected into a list (it being understood that such list may comprise one or more entries in a database file, or other electronic file compiling attendee identifications in suitable form so that they may be electronically linked with specific exhibitors). Preferably, summary information about each exhibitor's list of leads is accessible to that list's respective exhibitor enabling the exhibitor to contact such leads as described in greater detail below.

Optionally, issuance of leads may be governed by subscription rules allowing differing numbers of leads to be accessible to the exhibitor dependent upon the class of lead subscription they ordered.

In order to generate the lead lists for each exhibitor, the data used to generate that list is sorted into conceptual bins of two types, namely, Product Category Bins and Exhibitor-Specific (or other User-Specific) Bins. Product Category Bins collect demographic and behavioral information from attendees (or other members of the relevant population), and for each attendee associated with a Product Category Bin, provide a qualitative lead score and a rank based on that score against other attendees associated with that bin. Additionally, each Product Category Bin may have keywords associated therewith. As discussed in greater detail below, a keyword associated with a Product Category Bin serves to identify attendees, and thus add attendees to the bin, when an attendee issues a search query for a potential business partner using one of the keywords associated with such bin.

Each Product Category Bin identifies a single product category, and associates with such bin Products of Interest that relate to the Product Category for that bin, and any keywords that have been associated with such Product Category. Preferably, an expert knowledge provider may have administrative access to the data in each bin in order to receive, approve, and attach to bins new search keywords submitted by exhibitors that are likewise associated with such Product Category.

In order to submit a new keyword, an exhibitor may, using their Lead Profile form, select a Product Category that they wish to use in order to locate (as leads) those attendees having a specific interest in a given Product Category. Preferably, as shown on the Leads Profile screen of FIG. 8, a user may view the associated keywords and phrases associated with any single Product Category by engaging a “View associated keywords and phrases” function, which function directs the user to a “Keywords and phrases associated with Product Category” screen as shown in FIG. 8a. Such Keywords screen preferably displays all of the keywords associated with a specific Product Category. A user is optionally prompted to input a new keyword or phrase for inclusion in the list of keywords for the given Product Category, and may do so by simply typing the desired keyword in a keyword submission data field and engaging a “submit” function. Once the “submit” function is engaged by the user, it is directed to a keyword review cue where such new keyword may be reviewed by a system administrator for approval. Should the administrator approve the newly submitted keyword, it is added to the list of keywords associated with that Product Category for all users.

When an attendee performs a keyword search, the contents of their search is compared against the existing list of approved keywords. If their search query contains a keyword, that attendee's user identification is added to the bin for the Product Category associated with that keyword. Through the interactions of the attendees with the system, including the information they initially use to populate their User Profile and their behavior within the system to locate potential business partners, data elements are added to Product Category bins, which data elements preferably include the user ID for each user whose demographics and/or behavior matches the criteria set up for that bin, a date for the first behavior (which, in the context of a trade show, would typically comprise the date on which such attendee or other user registers with the system), an ever-changing date for the most recent behavior which placed the user in or updated the user's information in the bin, and a cumulative score (calculated as detailed below) for each attendee user ID in the bin relating to the degree of correlation between the bin criteria and the specific attendee's demographic information and behavioral traits.

It is noted that each of the Leads Profile categories shown on FIG. 8, namely, Primary Businesses, Job Functions, and Product Categories preferably provides a functionality to allow the exhibitor to update their choices under each such category by engaging an update function. For instance, upon engaging an “Update Product Categories criteria” function, the user is presented with a Product Categories selection screen as shown in FIG. 8b enabling the selection of different Product Categories to add to their Leads Profile criteria.

As mentioned above, the second type of conceptual bin is an Exhibitor-Specific (or other User-Specific) Bin. There is preferably one Exhibitor-Specific bin for each exhibitor, which collects attendees that exhibit behaviors that are specifically directed at the exhibitor's company, products or people. Preferably, the Exhibitor-Specific bins particularly collect the unique attendee user ID's for each attendee associated with the bin, their initial behavior date, the type of behavior directed against the company, the date of the most recent behavior, and an overall score (calculated as detailed below) for each attendee user ID in the bin. The attendee behaviors that are considered in determining how to score an attendee within an Exhibitor-Specific bin preferably include company-specific behavior, product-specific behavior, and people-specific behavior. Possible company-specific behavior may include conducting keyword or phrase searches conducted by the attendee, which searches include the company's name, viewing the company's profile, and clicking through a link provided on the company's profile to the company's website. Possible product-specific behavior may include keyword searching for one of the company's specific products, viewing a Product Profile for one of the company's products, or (in the context of a trade show environment) voting for a specific product as, for example, a “show favorite.” Further, people-specific behavior may include searching for a specific employee's name, viewing a particular employee's connection details (explained in detail below), sending or accepting a Connection Request to an employee (explained in detail below), and opening any system-generated communication to such attendee.

When an attendee (or other user of the relevant population) initially registers with the system, demographic information is collected from their User Profile and from any subsequent revisions that they make to their User Profile. Once registered with the system, the attendee's Products of Interest are mapped to Product Categories using an Exhibitor's Product Categories to Attendee's Products of Interest mapping file. The resulting list of Product Categories is evaluated against the criteria associated with each bin. If the attendee's Product of Interest matches one or more of a bin's Product Categories, then the user ID for that attendee is added to the bin with an initial score of 1. As more of the attendee's Products of Interest are evaluated, the user ID and score is added to other bins. If the user matches more than once on any bin, the score for that user ID is incremented by one in that bin. The same data is evaluated for each user in the system and scored into the bins. As a result, bins will contain various numbers of user ID's with different scores. Preferably, changes made to a user's User Profile will be propagated through and will appropriately modify the contents of the relevant bins. For instance, if an attendee adds a Product of Interest, then the data in the appropriate bins will be incremented. If the attendee removes a Product of Interest from his User Profile, then the data in the appropriate bins is decremented.

As mentioned above, searching activity by a user is likewise a behavior that will cause scoring and ranking in a bin, such as searching product categories, companies, people, educational sessions at a trade show, keywords, etc. Keyword searches by each attendee are evaluated against the current community-specific list of approved keywords. More particularly, each time an attendee searches using a query containing an approved keyword for a particular bin, their user ID is added to the bin with an initial score of 1. If that user ID is already in the bin, his score is incremented by 1.

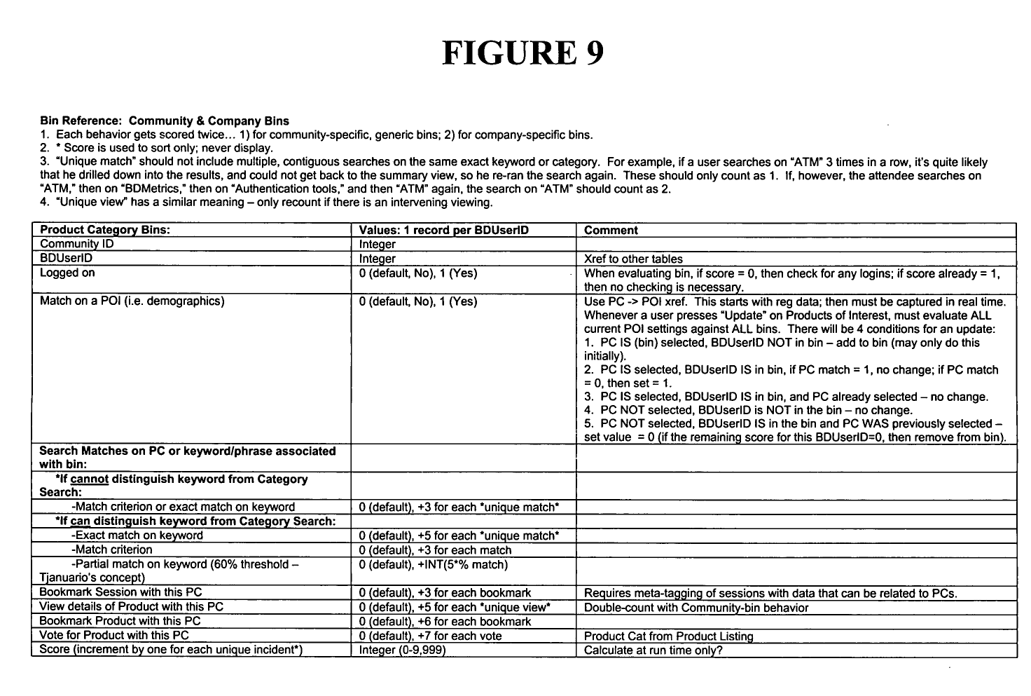

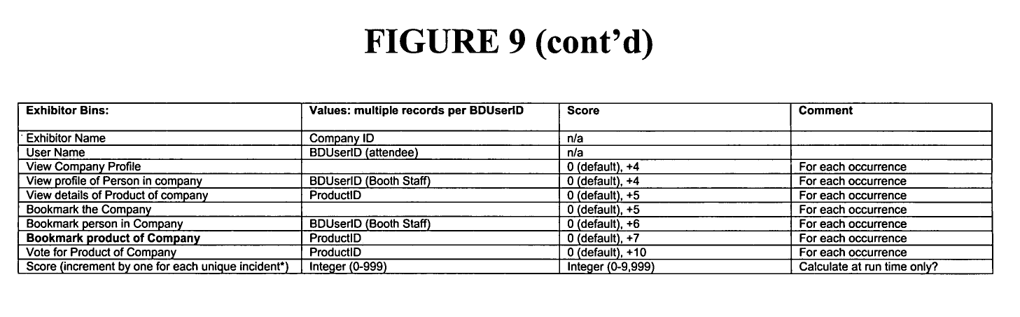

The scoring for various behaviors and demographics will now be explained. As shown in FIG. 9, exemplary data elements associated with both Product Category bins and Exhibitor-Specific bins are presented. A Product Category bin preferably carries the following data elements:

a. a code identifying the specific product category (Community ID)

b. a user ID for the attendee(s) in the bin;

c. an indication of whether the specific attendee is logged on to the system;

d. an indication of whether there was a match on a Product of Interest (from the attendee's User Profile, using a Product Category to Product of Interest mapping);

e. an indication (and score value) of whether the attendee has searched using a matching keyword or Product Category;

f. an indication (and score value) of whether the attendee has bookmarked a session (i.e., and educational session at a tradeshow) relating to the Product Category of the bin;

g. an indication (and score value) of whether the attendee has voted for a product as a “best of show” product in the Product Category of the bin; and

h. a final score for the attendee based on the above values.

Notably, the specific values presented for each score may be modified as experience dictates by those of ordinary skill in the art to customize the relative strength of each criteria without departing from the spirit and scope of the invention. Likewise, other values and metrics (i.e., behaviors) could be added to the above to provide a more refined scoring for each attendee and the degree of association they have with any given Product Category.

Similarly, an Exhibitor-Specific bin preferably carries the following data elements:

a. a code identifying the specific Exhibitor (Company ID)

b. a user ID for the attendee(s) in the bin;

c. an indication (and score value) of whether the specific attendee has viewed the exhibitor's User Profile;

d. an indication (and score value) of whether the specific attendee has viewed the User Profile of an individual person within the Exhibitor Company;

e. an indication (and score value) of whether the specific attendee has viewed the details of a Product of the Exhibitor Company;

f. an indication (and score value) of whether the attendee has bookmarked the Exhibitor Company;

g. an indication (and score value) of whether the attendee has bookmarked an individual person within the Exhibitor Company;

h. an indication (and score value) of whether the attendee has bookmarked a Product of the Exhibitor Company;

i. an indication (and score value) of whether the attendee has voted for a product of the Exhibitor Company as a “best of show” product; and

j. a final score for the attendee based on the above values.

Once again, the specific values presented for each score may be modified as experience dictates by those of ordinary skill in the art to customize the relative strength of each criteria without departing from the spirit and scope of the invention. Likewise, other values and metrics (i.e., behaviors) could be added to the above to provide a more refined scoring for each attendee and the degree of association they have with any given Exhibitor Company.

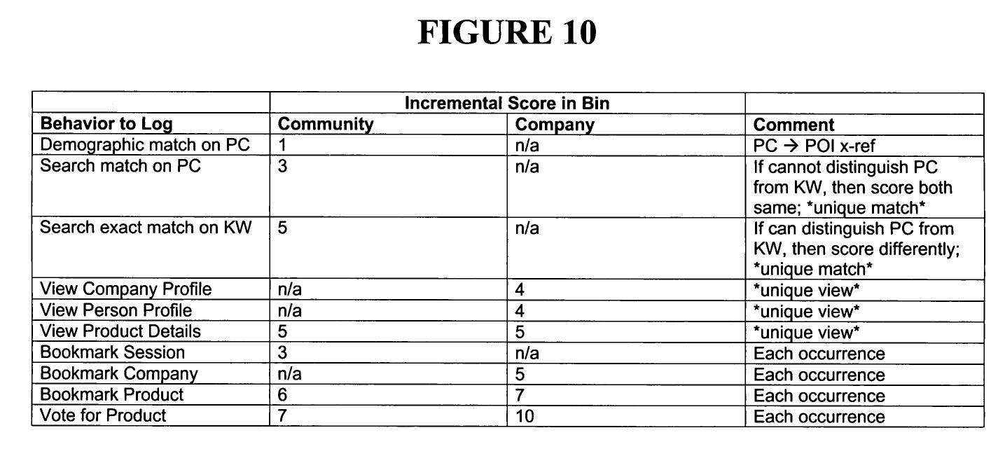

While exemplary only, FIG. 10 presents a summary chart of the various criteria and score values associated with such criteria in determining the scores that are to be associated with each User ID placed into a bin.

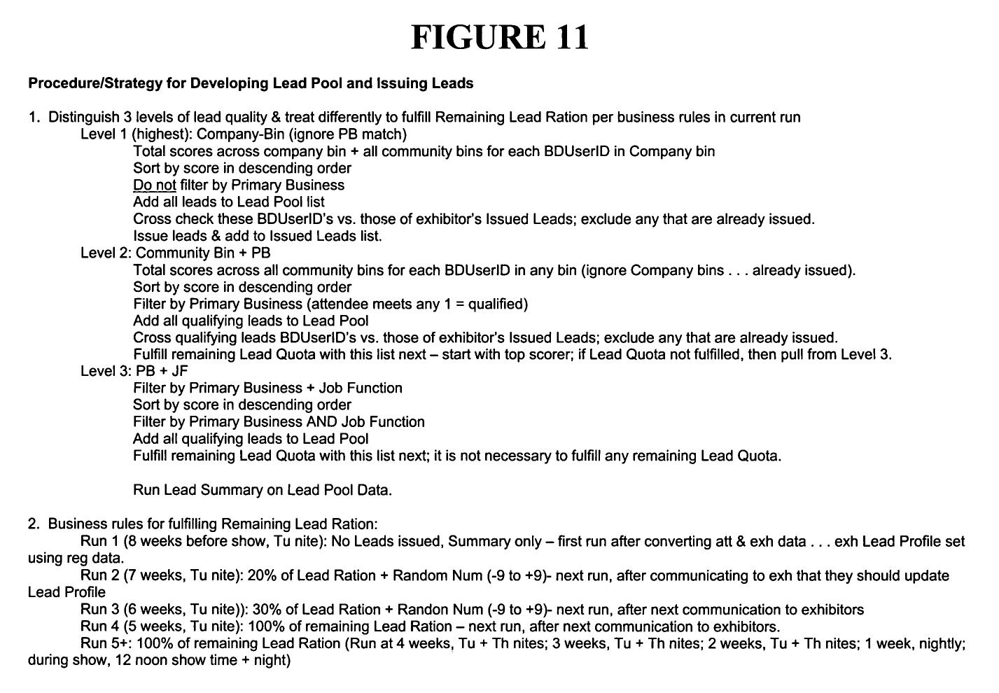

The foregoing discussion explains scoring of each user ID placed within either a Product Category bin or an Exhibitor Specific bin. However, in addition to providing a score for each such user ID, in order to appropriately distribute the contacts represented by the user ID's as leads, it is also desirable to rank the entries in each bin. As shown in FIG. 11, that ranking is preferably accomplished using a three stage screening process. More particularly, at level 1, all of the entries in each Exhibitor-Specific bin are analyzed in order to establish a ranking and disperse leads to such Exhibitor's Lead List. The exhibitor's Lead List is a listing of all potential leads for that exhibitor, and may optionally be provided to the exhibitor (as detailed below) in accordance with a distribution scheme that disperses select numbers of leads over time, in numbers that are determined by a subscription level purchased by the individual exhibitor. In the Level 1 analysis, the scores for each user listed in the Exhibitor-Specific bin are totaled. Likewise, for each such user listed in the Exhibitor-Specific bin, their scores in all related Product Category bins are likewise totaled, and this value is added to their prior score. Once these values are calculated for each entry in the Exhibitor-Specific bin, all entries are then sorted in descending order. All leads are then added to the Exhibitor's Lead List. The user ID's for all leads so placed on the Exhibitor's Lead List are then cross checked against the list of leads that have already been issued to such Exhibitor, i.e., those leads whose contact information has actually been forwarded to the specific Exhibitor, and any leads that have already been issued are deleted. This first level of analysis represents the top leads available for each exhibitor.

In the Level 2 analysis, the scores for each user listed in the Product Category bin are totaled and then sorted by score in descending order. Once sorted, the users are filtered by Primary Business criteria. In the user's own User Profile, during registration with the system, the user is prompted to enter their own Primary Business, and such data is stored in the user's User Profile. Such Primary Business data element may be a separate data element from those discussed above comprising the User Profile, or may optionally comprise the attendee's “My Product Offerings” data in their User Profile. If a specific attendee/user matches their own Primary Business with the Primary Business of the specific bin, then they are designated as a qualified lead in that bin. Once all attendees/users are evaluated, all resulting qualifying leads are added to the appropriate Lead Pool, i.e., they are added to the Lead Pool of each exhibitor that has a matching Primary Business with such bin. Preferably, such resulting qualifying leads are compared against the leads already in each Lead Pool before placement in such Lead Pool in order to exclude any leads that have already been placed in such Lead Pool.

In the Level 3 analysis, the remaining leads (those not already distributed to the exhibitor's lead list in Levels 1 and 2) are filtered by Primary Business and Job Function, classifying the remaining leads based on their individual Primary Business and Job Function criteria. As with the Level 2 analysis, if a specific attendee/user matches their own Primary Business or Job Function with the Primary Business or Job Function criteria of an Exhibitor-specific bin, then they are designated as a qualified lead in that bin, and added to such Exhibitor's Lead Pool.

Once the leads are distributed to the specific exhibitor's lead list as indicated above, they may optionally be transmitted to the actual exhibitor in accordance with a distribution scheme that portions leads based on a subscription level purchased by the individual exhibitor. For example, the system may automatically distribute a certain percentage of leads from the exhibitor's lead lists at evenly spaced time intervals until all leads in the exhibitor's lead list are so distributed.

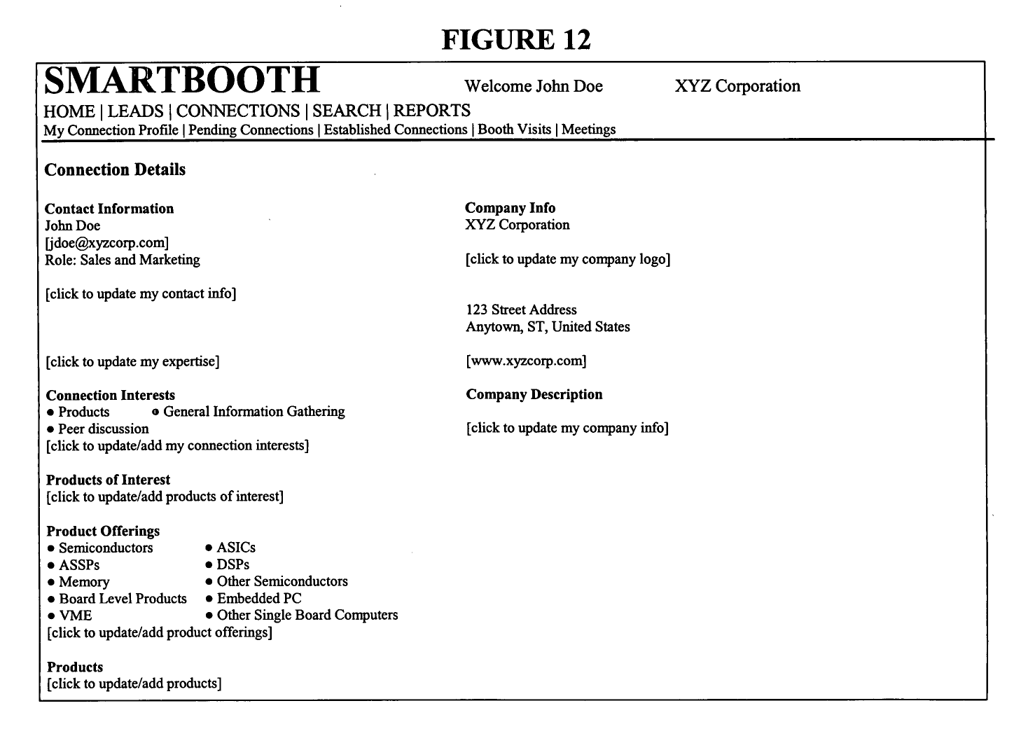

Distributed leads are made available to an exhibitor through a “Connections” function. While leads are determined for and distributed to exhibitors only, both exhibitors and attendees are provided such a Connections function. As shown in FIG. 12, an exhibitor (or attendee) may access a Connections Detail screen which summarizes the information that would be made available to those potential business partners with whom contact is made. Preferably, such information includes the individual's contact information including their role, the individual's area of expertise, their Connection Interests, their Products of Interest, their Product Offerings, and optionally specific products that they wish to promote to the population. Also included on Connection Details screen is preferably the individual's company information, including any description of the company that had been provided by that user.

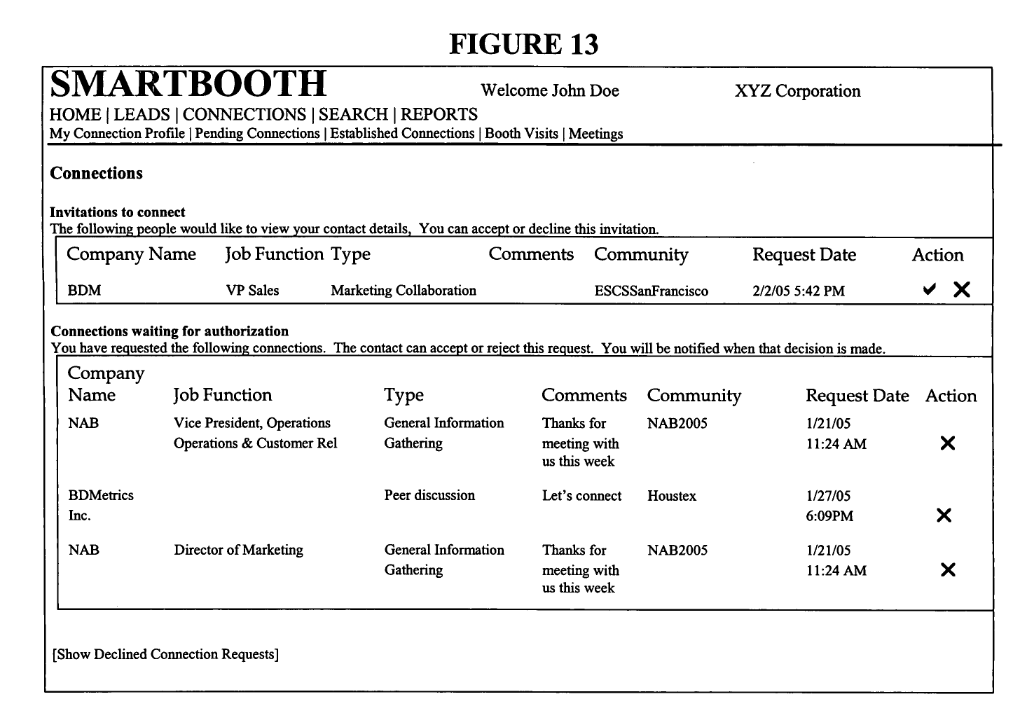

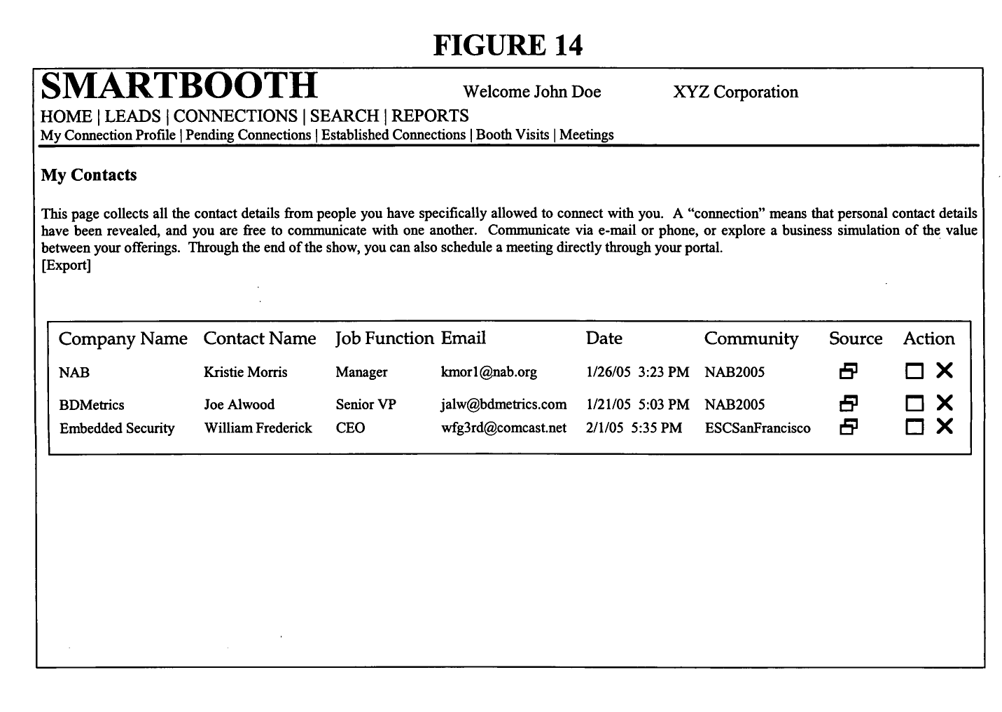

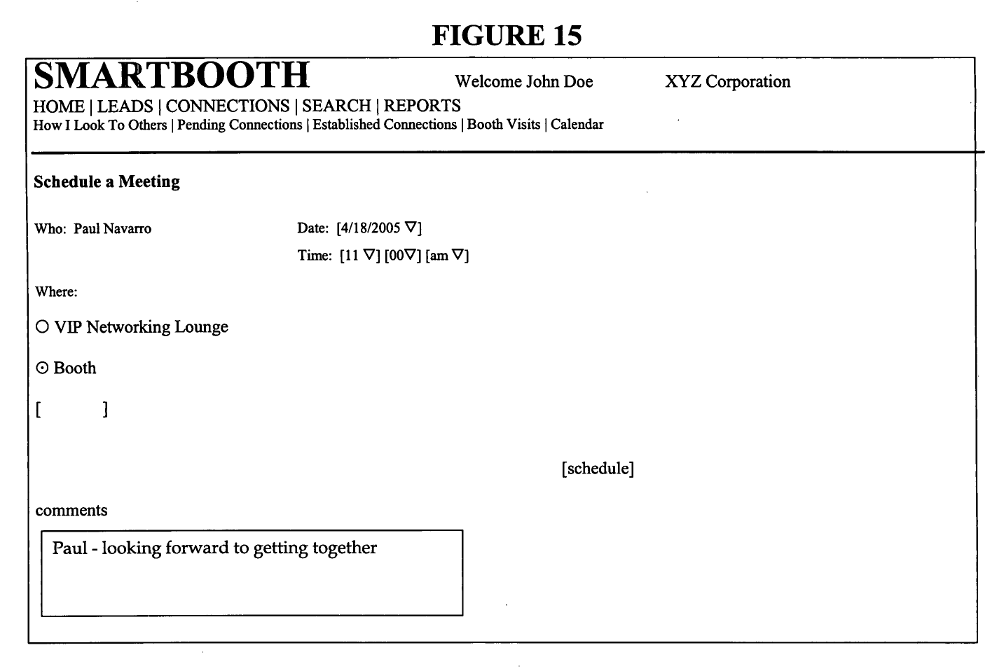

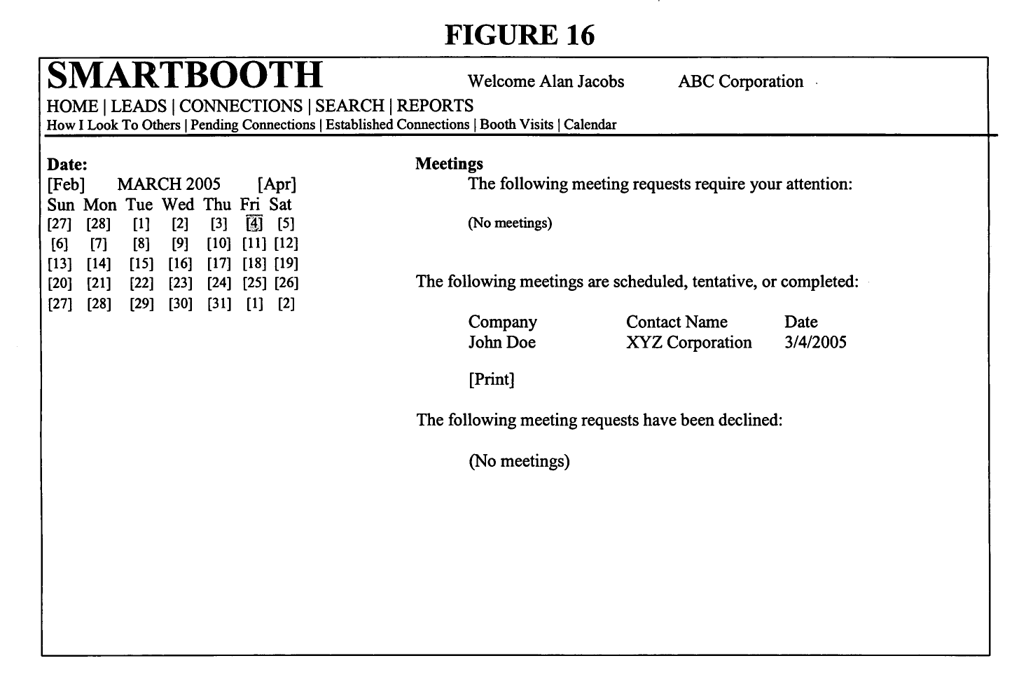

As a result of searching for potential business partners and locating those of interest, a user may send a connection request to such potential partner in an attempt to establish contact and pursue a potential business transaction. The process by which a user conducts such search and initiates a connection request is discussed in greater detail below. After such a connection request is either sent by the user or received from another user, it is reflected on a Pending Connections screen as shown in FIG. 13. More particularly, the Pending Connections screen provides “Invitations to connect” listing incomplete contact information for other users who have requested contact with the user. Such information preferably includes the company name, job function, and type of connection sought by the other users. Also provided on the Pending Connections screen is a “Connections waiting for authorization” listing incomplete contact information for other users with whom the individual user has requested contact. Again, such information preferably includes the other user's company name and job function, along with the type of connection sought by the individual user. After the individual users referenced on the Pending Connections screen accept an invitation to connect, they are then listed on an Established Connections screen as shown generally in FIG. 14. For each entry listed on the Established Connection screen, the user is preferably provided complete contact information, namely, a display of such other user's company name, contact name, job function, and email address so that direct communication may proceed with such other users. Optionally, a meeting scheduling function may be employed for each such contact to enable scheduling of a meeting with such contact. As shown in FIG. 15, employing the meeting scheduling function from the Established Connection screen will bring up a “Schedule a Meeting” screen providing opportunity to input a specific date and time for a meeting, along with comments the user wishes to send to the potential meeting partner. By engaging a schedule function, the user is then presented a Meeting Calendar screen as shown in FIG. 16 which displays any meeting requests made by the user, meetings scheduled, tentative, or completed, and meetings that have been declined by their invited partner. For outstanding meeting requests, a user may elect to accept the meeting, in which case the entry is moved from “meeting requests requiring attention” to scheduled meetings, and is noted on the user's calendar.

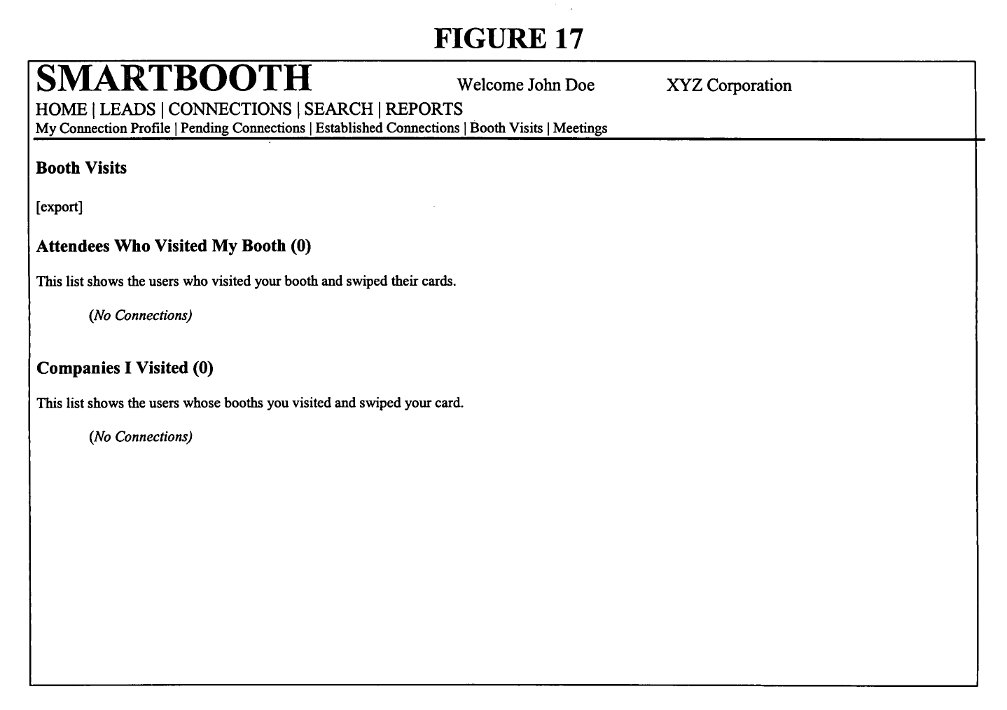

In a trade show environment, it is also desirable to maintain record of companies that the user has visited, and if the user is an exhibitor, record of individuals that have visited the user's own booth. Preferably, such connections are listed as a separate connection on a Booth Visits page (as shown in FIG. 17), which page preferably displays to the user the complete contact information for attendees/other users who visited the user's booth, along with the booths that such individual themselves visited. As explained in greater detail below, such data is used in order to create and display to the user metrics indicating the extent of contacts made among the relevant population.

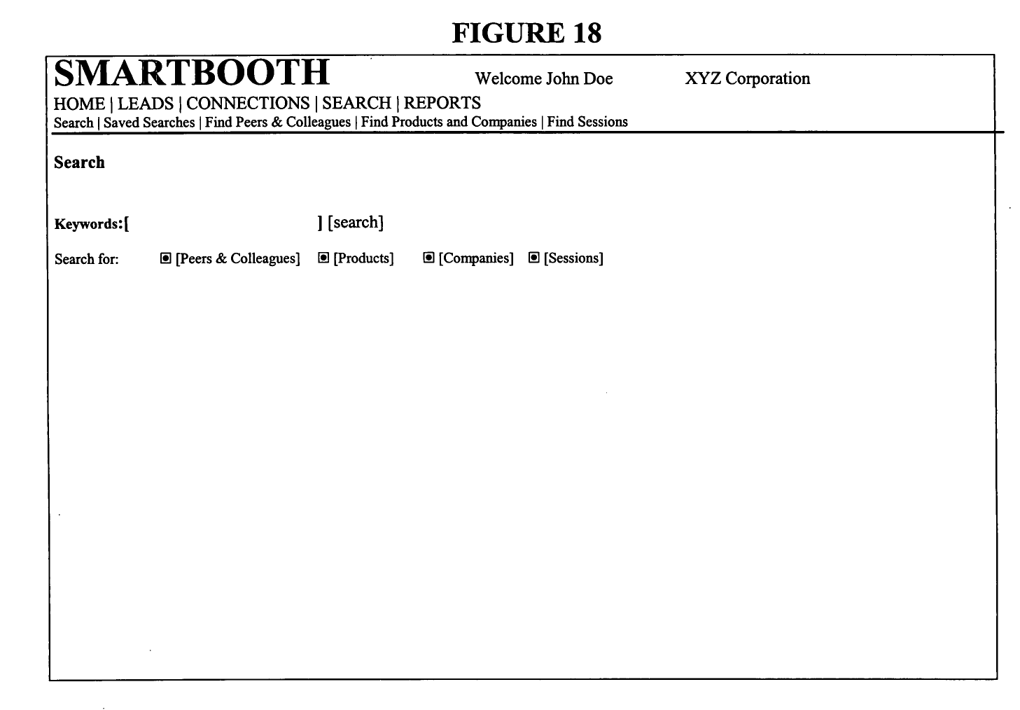

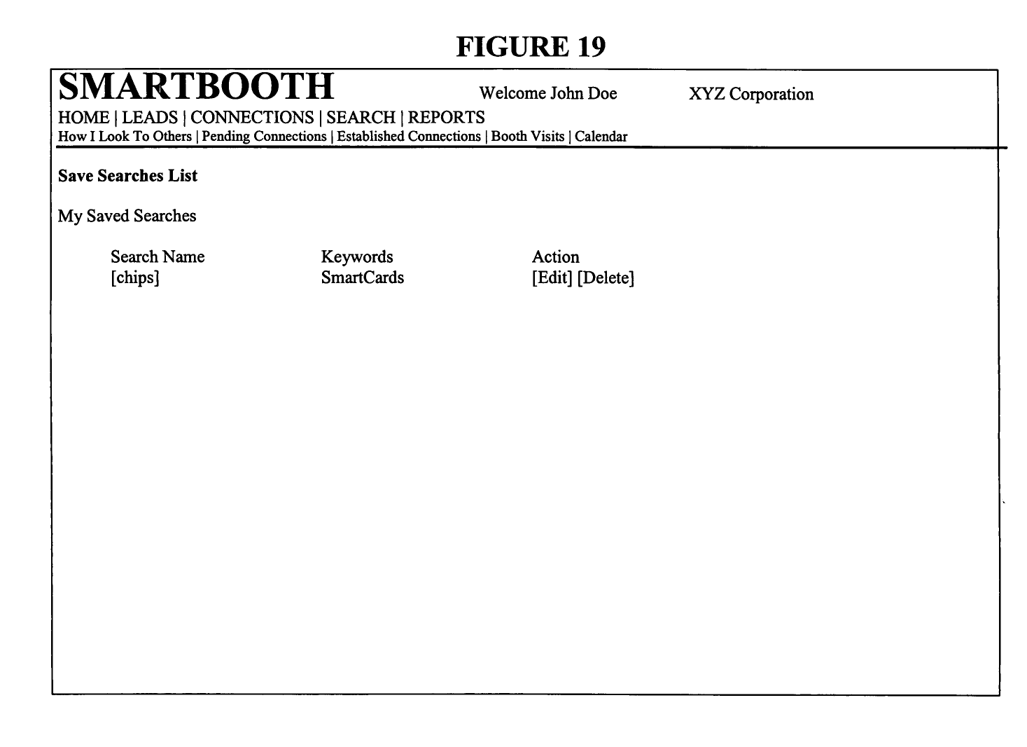

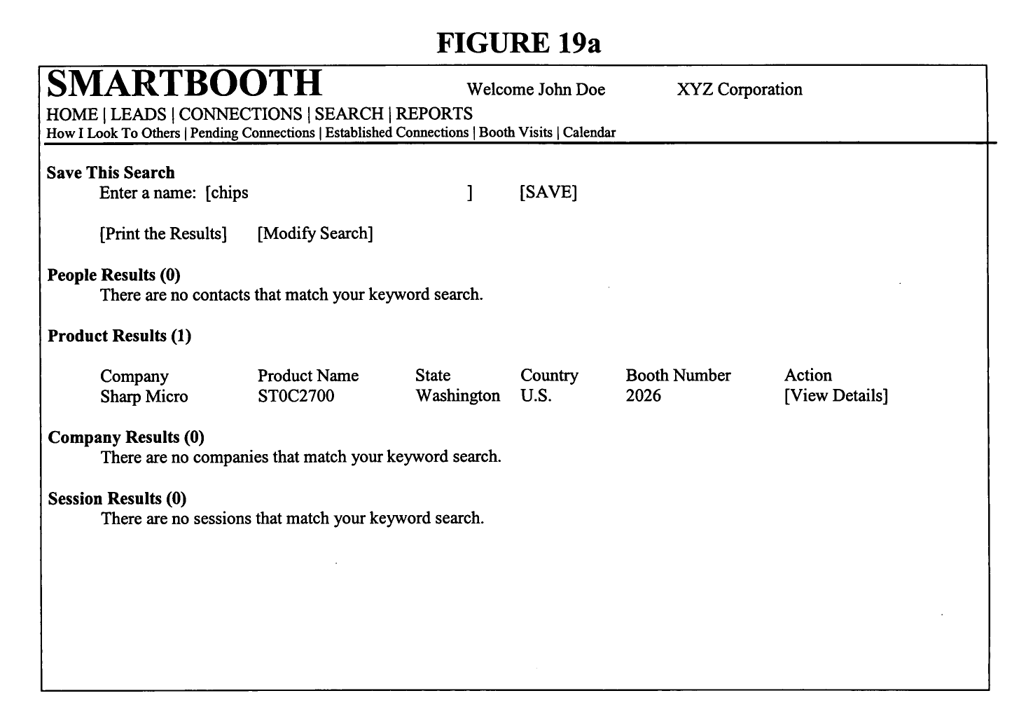

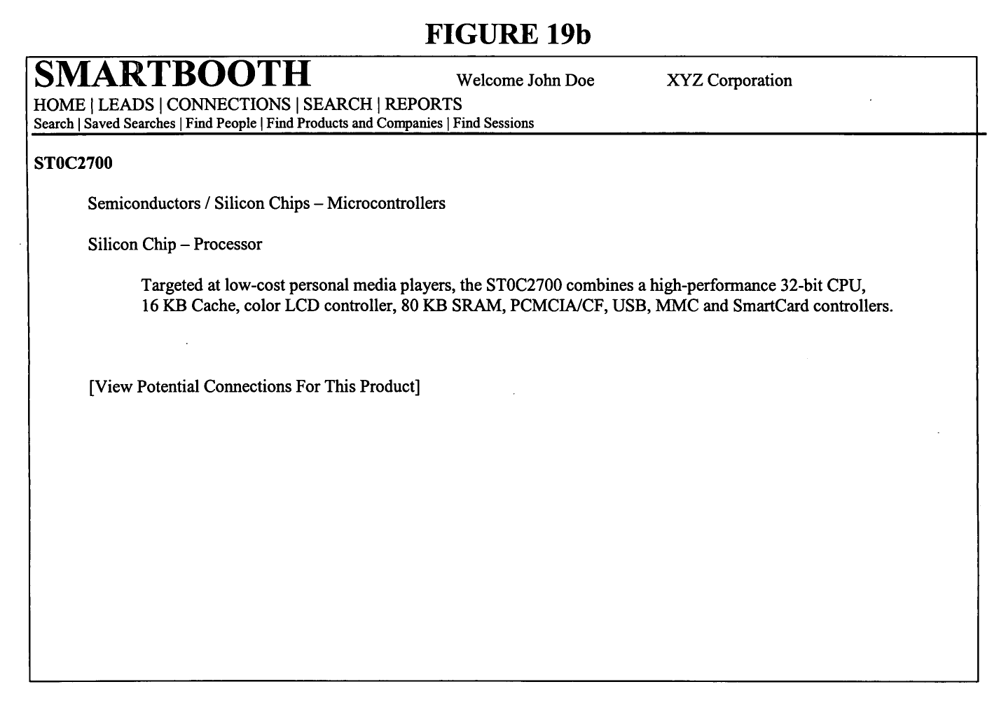

As mentioned above, it is also desirable for users to be able to search the relevant population in order to locate those entities with whom such user might wish to seek contact in order to, for example, pursue a potential business transaction. The system thus provides users a search functionality for this purpose. As shown in the exemplary Search function screen of FIG. 18, a user may enter a search query in a data entry field, and preferably is prompted to select categories in which such search is to be conducted. Preferably, such categories include people (“Peers and Colleagues”), products, specific companies, and optionally sessions to be held at a tradeshow. As shown in FIG. 19, prior searches conducted by the user are preferably saved on a Saved Searches List for recall by the user. Preferably, the name of the search provides an active link which, when activated by the user, presents the current results of such search on a Search Results screen as shown in FIG. 19a. The Search Results screen preferably provides results for each search category, namely, People Results, Product Results, Company Results, and Session Results matching the user's keyword search. Preferably, for any such results presented, a View Details function is enabled which, when activated by the user, presents a Results Detail screen as shown in FIG. 19b providing the relevant details for such results category.

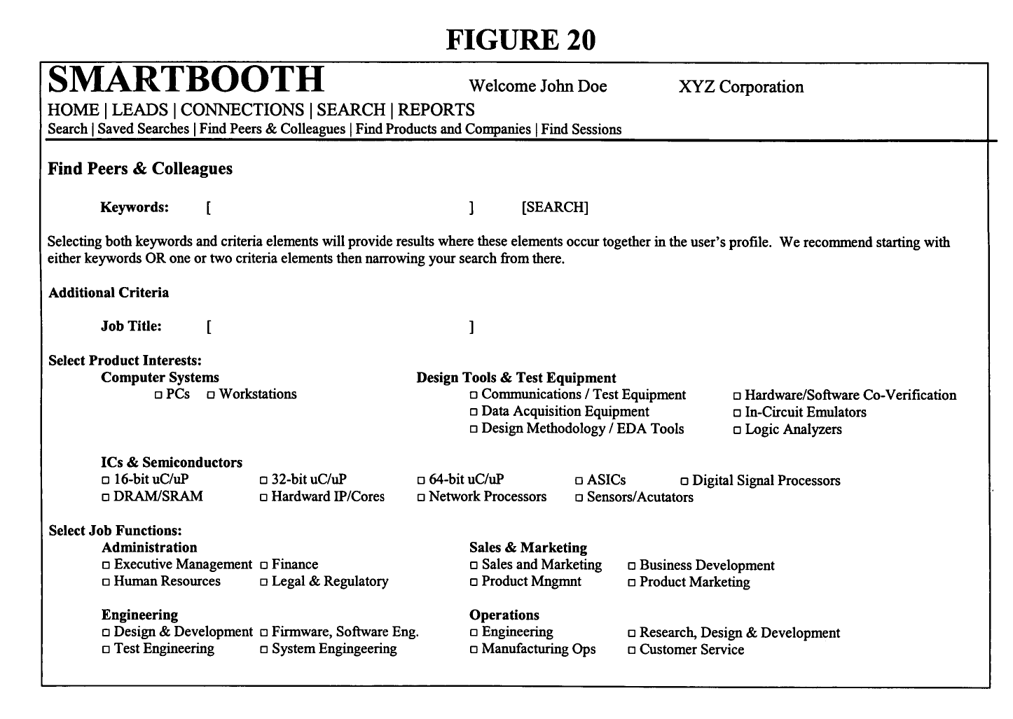

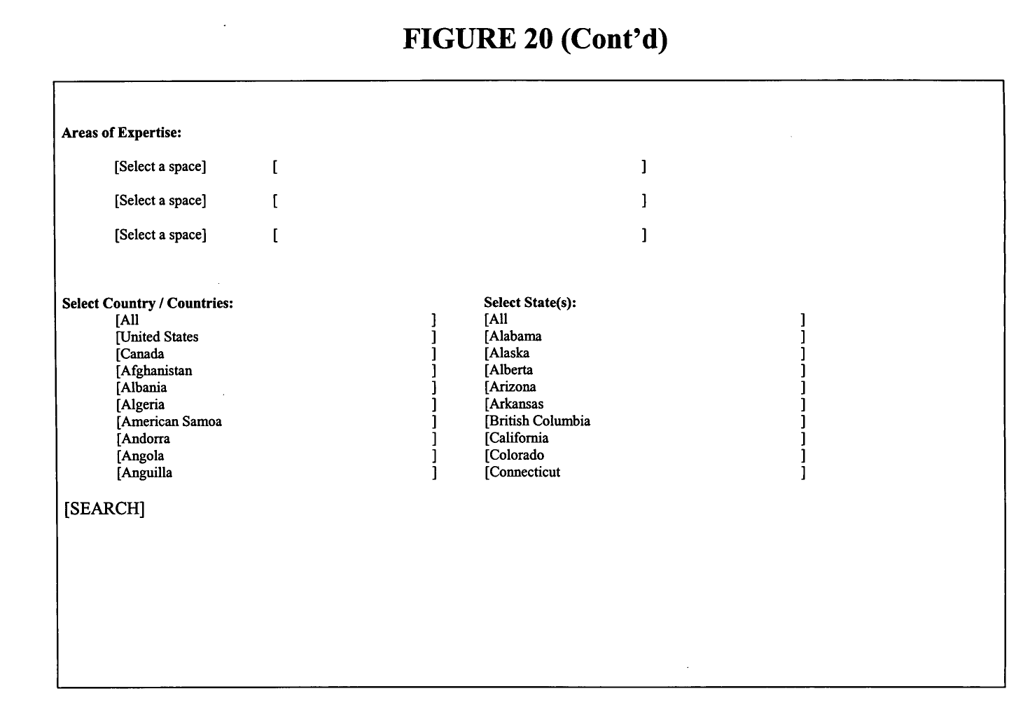

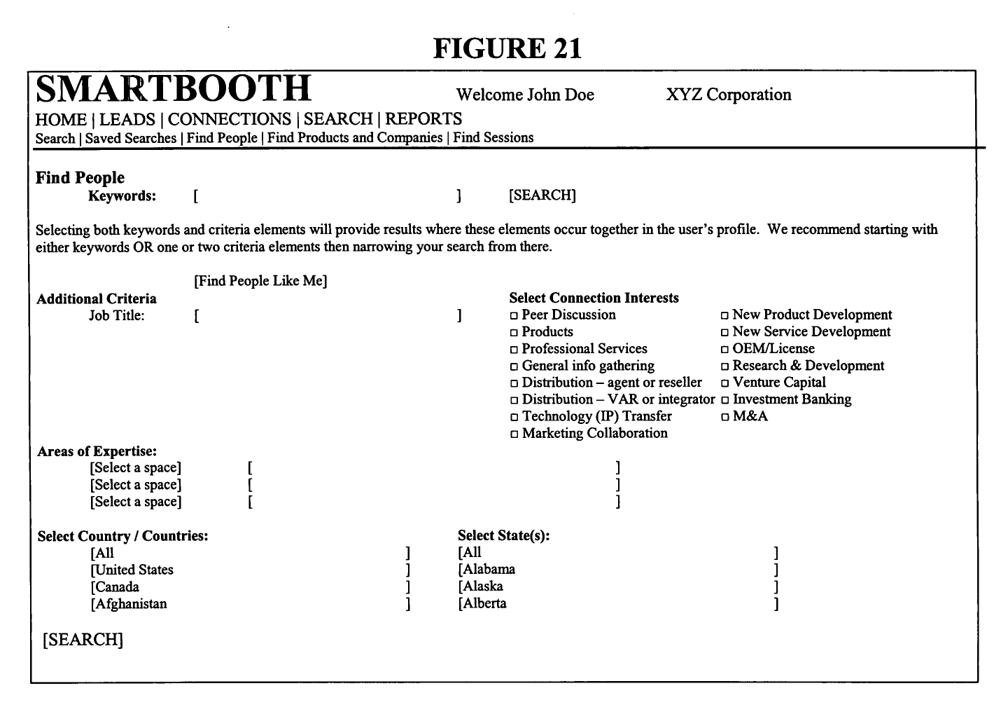

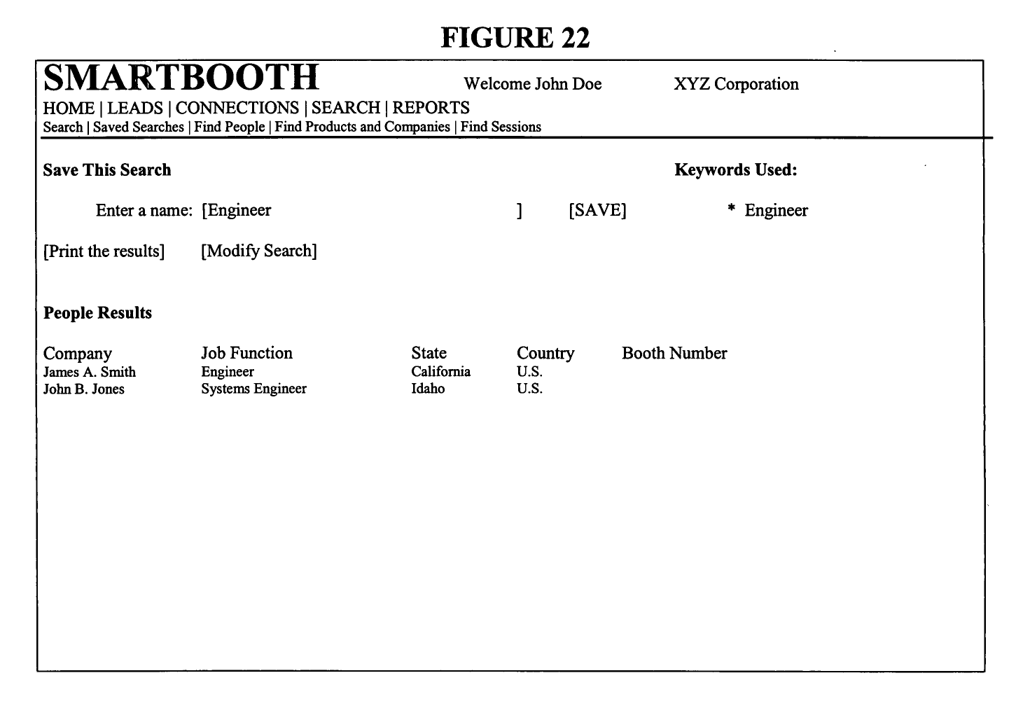

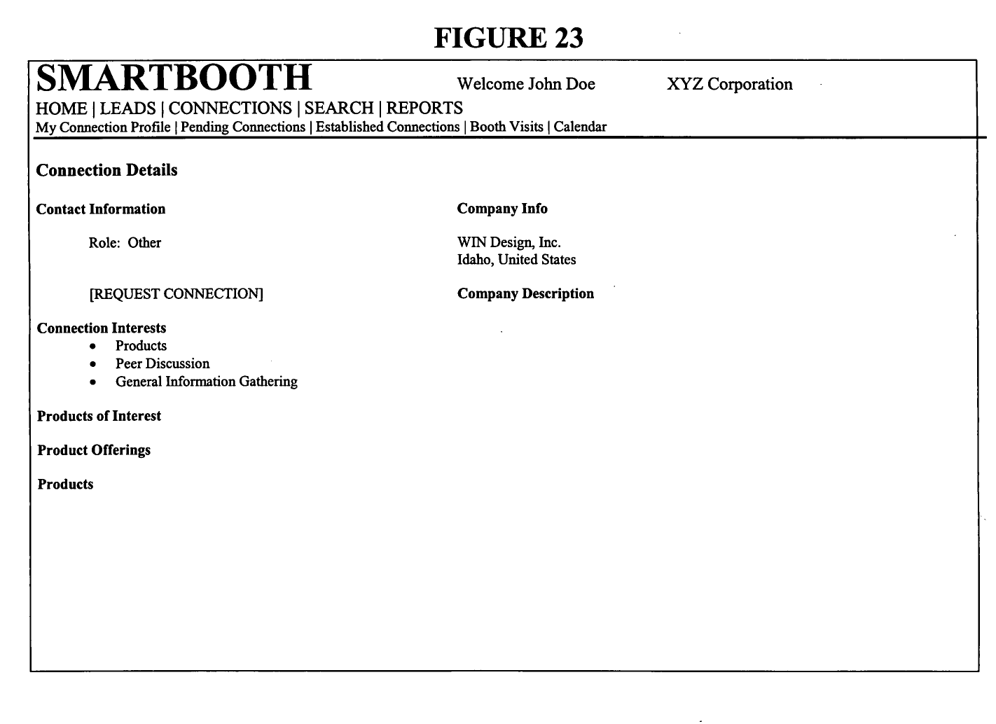

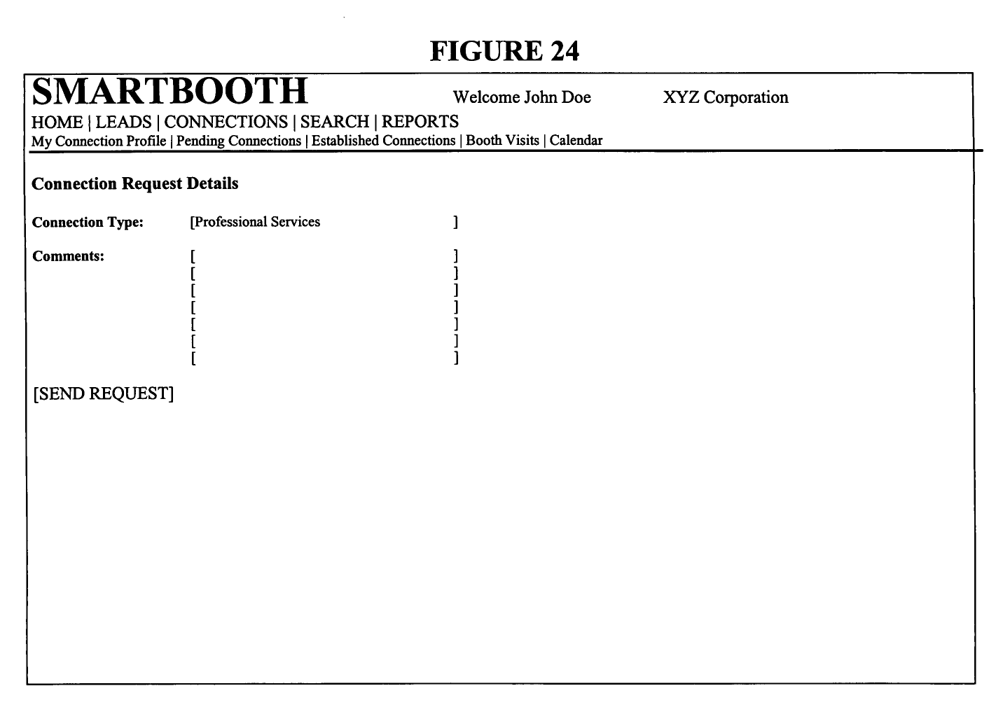

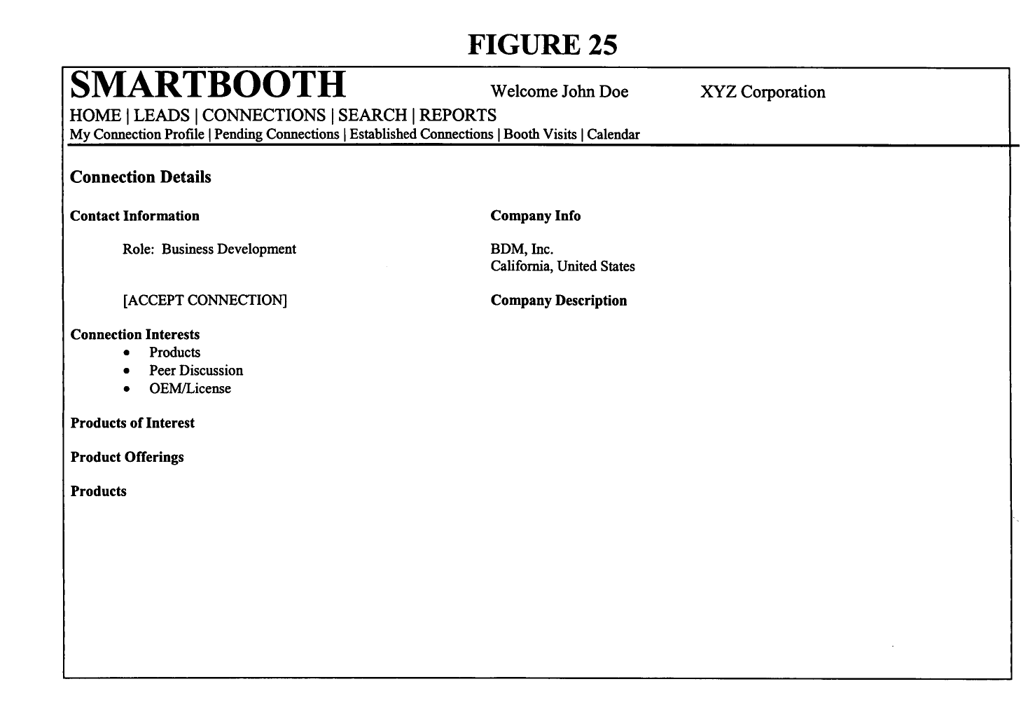

The data entered by the user on the Search function screen (FIG. 18) serves as a keyword for searching the various User Profiles of other users among the relevant population. In order to conduct a search for specific persons, as shown in FIGS. 20 and 21, respectively, the user is presented either a “Find Peers & Colleagues” screen (in the case of exhibitors) or a Find People screen (in the case of attendees) for conducting a search for specific persons having criteria in their User Profile matching the user's keyword search. As shown on the Find Peers & Colleagues screen of FIG. 20, the exhibitor is preferably prompted to enter one or more keywords in a data entry field, and to select additional criteria to refine their search, including the job title of the person they are seeking, specific product interests of the person they are seeking, specific job functions of the person they are seeking, areas of expertise of the person they are seeking, and the geographic location of the person they are seeking. Likewise, as shown on the Find People screen of FIG. 21, the attendee is preferably prompted to enter one or more keywords in a data entry field, and to select additional criteria to refine their search, including the job title of the person they are seeking, specific areas of expertise of the person they are seeking, specific market space with which the person they are seeking has associated their products or services, the desired connection type of the person they are seeking, and the geographic location of the person they are seeking. Each category selected, along with the keywords input by the user in each search screen, build a search query which is used to search the User Profiles of the relevant population and return results matching the criteria selected by the user on their respective search screen. For the people search, when one or more contacts are returned as a result of the search, they are preferably presented to the user in the form of a People Search Results screen as shown in FIG. 22. Each returned entry preferably provides an active link which, when activated by the user, presents a Connection Details screen as shown in FIG. 23 which displays relevant, incomplete connection information for the particular contact, along with a Request Connection function. When activated by the user, the Request Connection function presents the user with a Connection Request Details screen as shown in FIG. 24, prompting the user to input a desired Connection Type and any comments they wish to present the prospective contact when such contact is notified of the user's connection request. When the user completes such information, they may activate a Send Request function that in turn adds the contact entry to that user's Connections waiting for authorization, and likewise adds the first user's incomplete contact information to the prospective contact's Invitations to Connect, with an active link to the details for such user. Such prospective contact may activate such link to display the Connection Details for the user, as shown in FIG. 25, along with an Accept Connection function. When activated by the prospective contact, the Accept Connection function adds the user to the prospective contact's Established Connections screen with complete contact information for such user, and likewise adds the prospective contact to the user's Established Connections screen with complete contact information for such prospective contact.

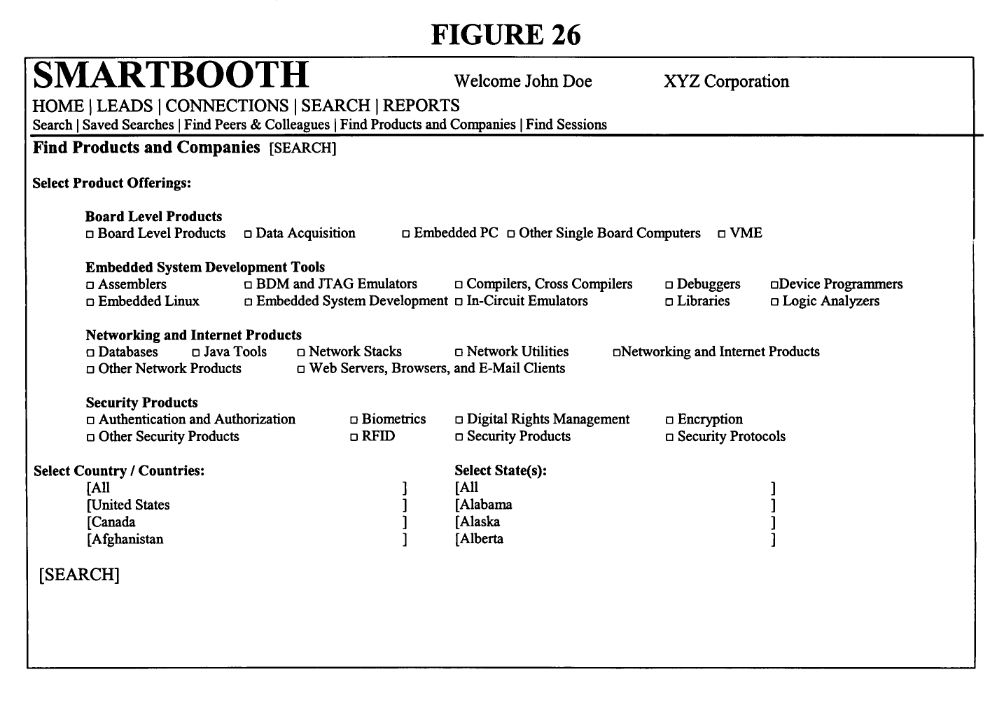

In order to conduct a search for specific products or companies, as shown in FIG. 26, the user is presented a Find Products and Companies screen enabling the user to select specific Product Offerings offered by other members of the relevant population, and optionally the geographic region in which such products are offered. As with a person search screen, upon the system identifying a match between the user's search and the Product Offerings data in another user's User Profile, such other user's incomplete contact information may be added to the user's Pending Connections screen so that a contact with such other user may be pursued.

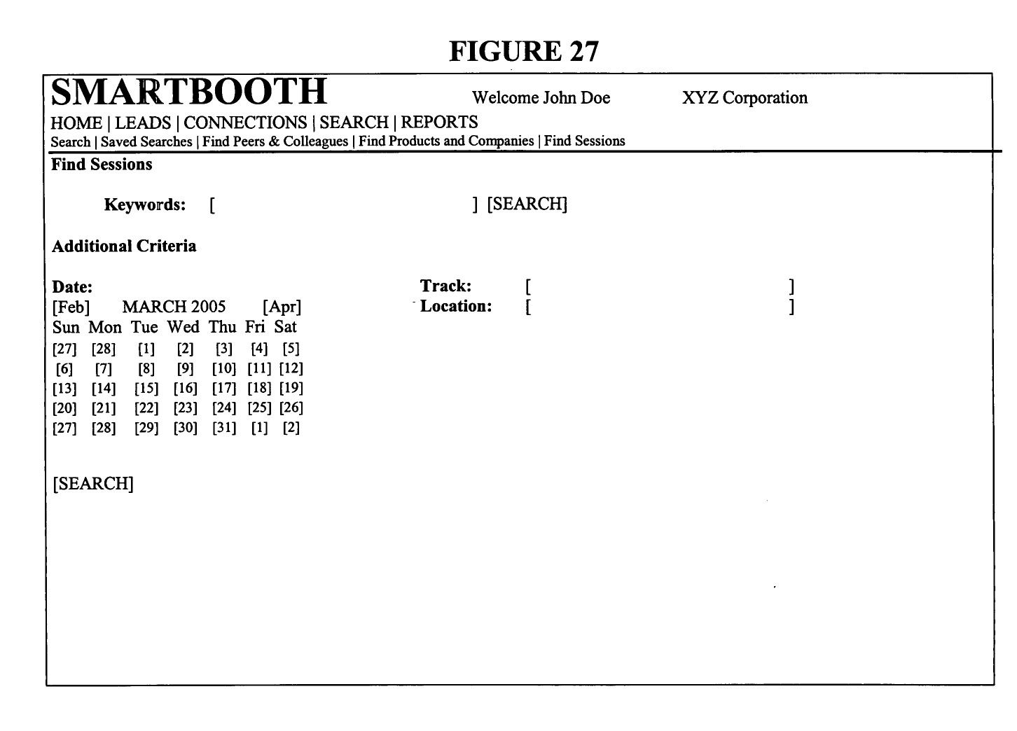

Lastly, in order to conduct a search for specific sessions (e.g., educational programs, promotional presentations, round-table discussions, etc.) offered in a trade show or other environment, a user may access a Find Sessions search screen as shown in FIG. 27. The Find Sessions search screen preferably prompts a user to input one or more keywords to search the names of available sessions, and likewise preferably allows the user to select additional search criteria including Track and Location. Track criteria preferably allows the user to select a specific track for a desired session in tradeshow environments in which multiple talent or expertise tracks are provided. Likewise, Location criteria preferably allows the user to select a specific geographic area in which such session would be offered. Based on the user's keywords and selected search criteria, in response to the user initiating a Search function, the user is presented a Sessions results screen (not shown) which preferably provides a listing of all sessions matching such keywords and selected search criteria, and optionally allowing the user to view details concerning each such revealed session.

Lead Conversion Process

The above described process of identifying and tracking leads is useful to allow users of the system to establish contact with prospective business partners. However, the method and system also provides opportunity for users to establish early connection with prospective leads, and to track interaction with such prospective leads over a period of time. Such tracking process over time provides a user, and particularly a user in the position of an exhibitor, to track success in converting leads generated into actual business partners.

More particularly, the entire relevant population (e.g., the entire attendance of a tradeshow) represents a target lead population. From that target lead population, a subset are identified as qualified leads, i.e., those members of the relevant population that exhibit qualification behaviors as the user has defined in their Leads Profile. As discussed at length above, such behaviors may include keyword searching by other users using terms associated with the exhibitor's own User Profile (such as the exhibitor's product offerings), searching on product categories that match the exhibitor's product offerings, viewing the exhibitor's products or company profile, and a user having the other above-described product-of-interest categories in their User Profiles that correspond to the exhibitor's profile. From such collection of qualified leads, an additional subset may be identified of users who have received the exhibitor's invitation to connect. Lastly, of those individuals, a final subset may be identified of users with whom a connection has been accepted. Thus, those individual users in the final connect population represent users who have been processed through the lead conversion process of target lead to qualified lead to contacted lead to connection. Having identified the connections established, the contact data (and any other data of interest from such connection contacts' User Profiles) may be exported to, for example, a Customer Relationship Management (“CRM”) program for further analysis and follow up.

Once again, this process is preferably carried out over time so that each user's interaction with the program with which the method and system herein are to be used, such as a tradeshow, may likewise be extended. Through such expanded interaction of users with such program environment, the administrators of the program may obtain greater value by driving additional interest in the program than would be possible by limiting the users' involvement to simply the multi-day window of the program/tradeshow itself. By expanding the opportunity for users to establish business connections over a greater period of time, the users extract greater value from the program experience, and thus are more apt to participate in the program in the first place, thus increasing sales of program registrations for the administrators.

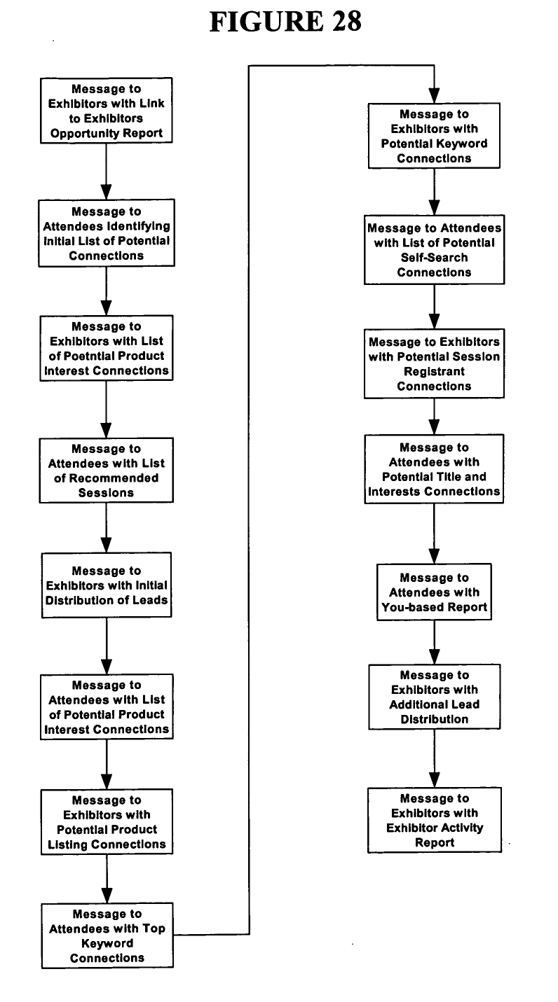

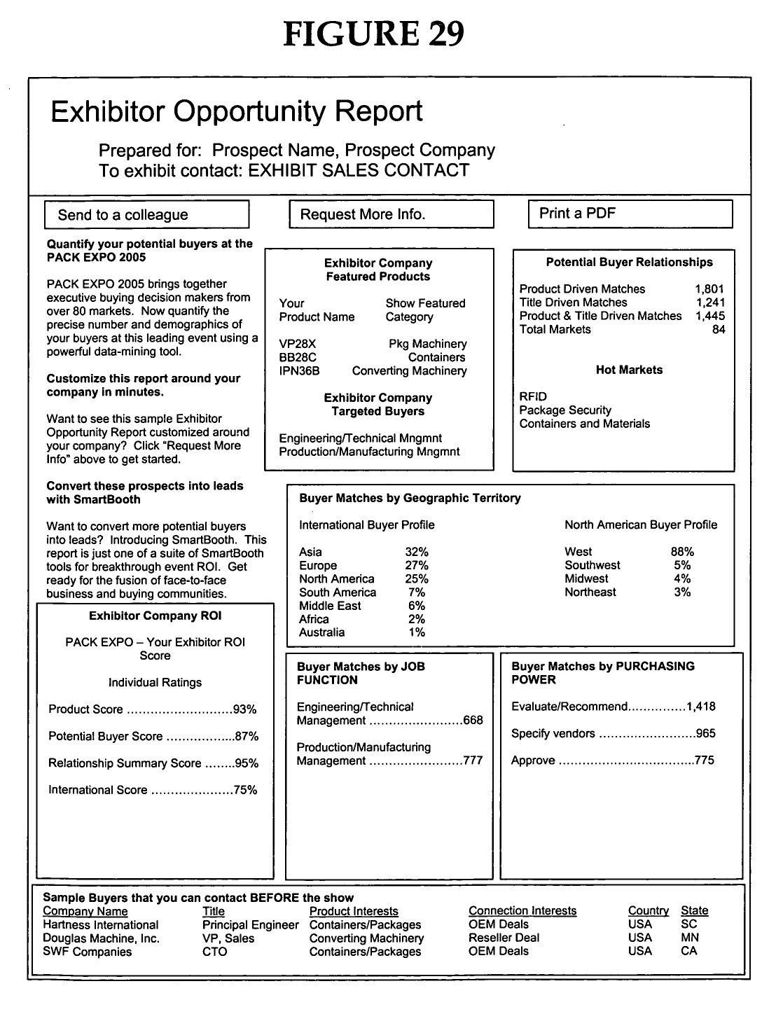

An example of how such lead conversion process may be spread over time will now be discussed. As shown in FIG. 28, the process may begin with distribution of a message, such as an electronic mail message, to exhibitors inviting them to engage the system to view members of the relevant population (e.g., attendees) that will be interested in that exhibitor's products, and providing a link to an Exhibitor Opportunity Report that summarizes information indicating the prospective business partners in the relevant population. An exemplary Exhibitor Opportunity Report is shown in FIG. 29, and may include such data elements as summaries of the exhibitor's own products and targeted buyers; an indication of the number of prospective buyers that are present in the relevant population corresponding to the exhibitor's various product, purchaser, and market criteria in the exhibitor's User Profile; the return on investment (“ROI”) the exhibitor may expect based upon the products they plan to exhibit at the program (including a metric indicating a degree of relevance of the exhibitor's products or services to the attendee population based upon the data in the attendee population's User Profiles); geographic locations of purchasers for the exhibitor's products or services (based on the data in the attendee population's User Profiles); the number of prospective purchasers for the exhibitor's products in particular job functions; the number of prospective purchasers for the exhibitor's products with particular purchasing authority; and a sample list of actual contacts that the exhibitor may pursue based upon the lead distribution process described above. Other categories of data and metrics may likewise be provided from the data in each of the exhibitor's and attendee's User Profiles in order to display to the exhibitor, at an early stage, the benefit that may be gained through their participation in the event.

At a point after issuance of the Exhibitor Opportunity Report, the system preferably forwards a message to attendees indicating a number of contacts of potential value for the specific attendee. Such list is preferably compiled by automatically engaging the above-described search functions to locate other system users whose User Profile data, and preferably whose job functions and areas of expertise data elements, match the user's own such data. Such list also enables the attendee receiving the message to engage the connections function described above with each user on such list, the contacts being initially treated as pending connections.

Next, the system preferably forwards a message to exhibitors indicating a number of attendee contacts of potential value for the specific exhibitor. Such list is preferably compiled by automatically engaging the above-described search functions to locate attendees who have listed in their Product Interests products of a type offered by the particular exhibitor.

Optionally, the system then forwards a message to attendees indicating a number of sessions of potential value for the specific attendee. Such list of sessions is preferably compiled by automatically engaging the session search function described above on behalf of each attendee to identify sessions of potential interest to such attendee. The automatic search may be conducted by automatically pulling data from a number of data elements in the attendee's User Profile, such as the particular attendee's Products, Expertise, Product Interests, or Product Offerings.

The system then preferably forwards a message to exhibitors indicating a number of attendee contacts of potential value for the specific exhibitor. Such list is preferably compiled by distributing a select number of leads in that exhibitor's lead list to the specific exhibitor. Such list again enables the exhibitor receiving the message to engage the connections function described above with each attendee on such list, the contacts being initially treated as pending connections.

Thereafter, the system preferably forwards a message to attendees indicating a number of products available from other users that may be of interest to such attendee receiving the message. Such list is preferably compiled by automatically engaging the above-described search functions to locate Product Offerings of other users that match the specific attendees keyword search criteria. Such list also preferably enables the attendee receiving the message to engage the connections function described above with each user on such list, the contacts being initially treated as pending connections.

Next, the system preferably forwards a message to exhibitors indicating a number of attendees who have searched on such exhibitor's Product Listings.

Next, the system preferably forwards a message to attendees informing such attendees of a number of top keywords used by other users having similar User Profiles (e.g., similar or related job functions, market spaces, product interests, etc.) in conducting searches.

Next, the system preferably forwards a message to exhibitors indicating a number of attendees that have searched on keywords that relate to such exhibitor's products.

The system then preferably sends a message to attendees providing a list of other users that have searched on such attendee, and optionally enables the attendee receiving the message to engage the connections function described above with each user on such list, the contacts being initially treated as pending connections.

Next, the system preferably sends a message to exhibitors indicating a number of attendees that have registered for sessions relating to such exhibitor's products.

Thereafter, the system preferably forwards a message to attendees indicating a number of other users that are most similar in User Profiles to the particular attendee, and optionally enables the attendee receiving the message to engage the connections function described above with each user on such list, the contacts being initially treated as pending connections.

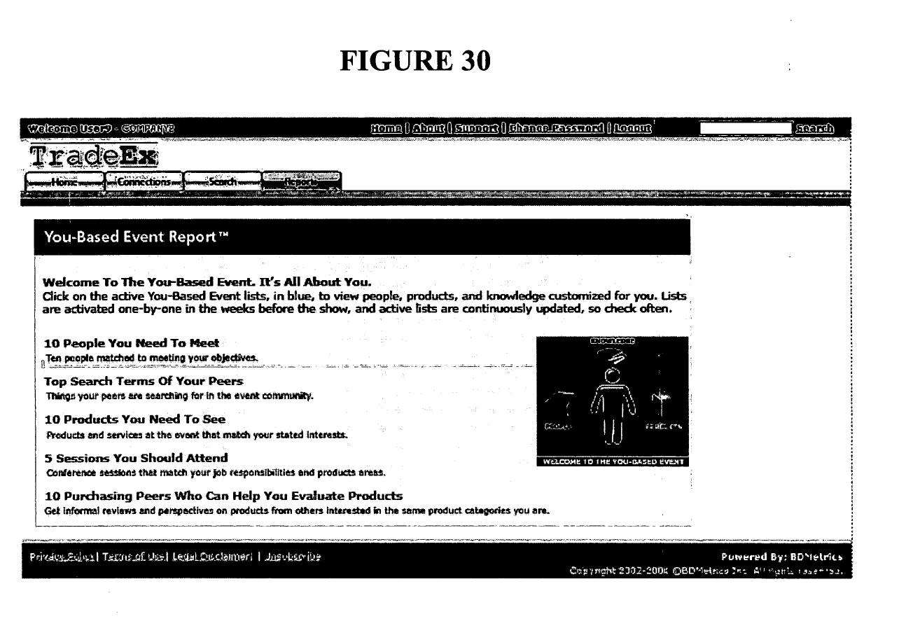

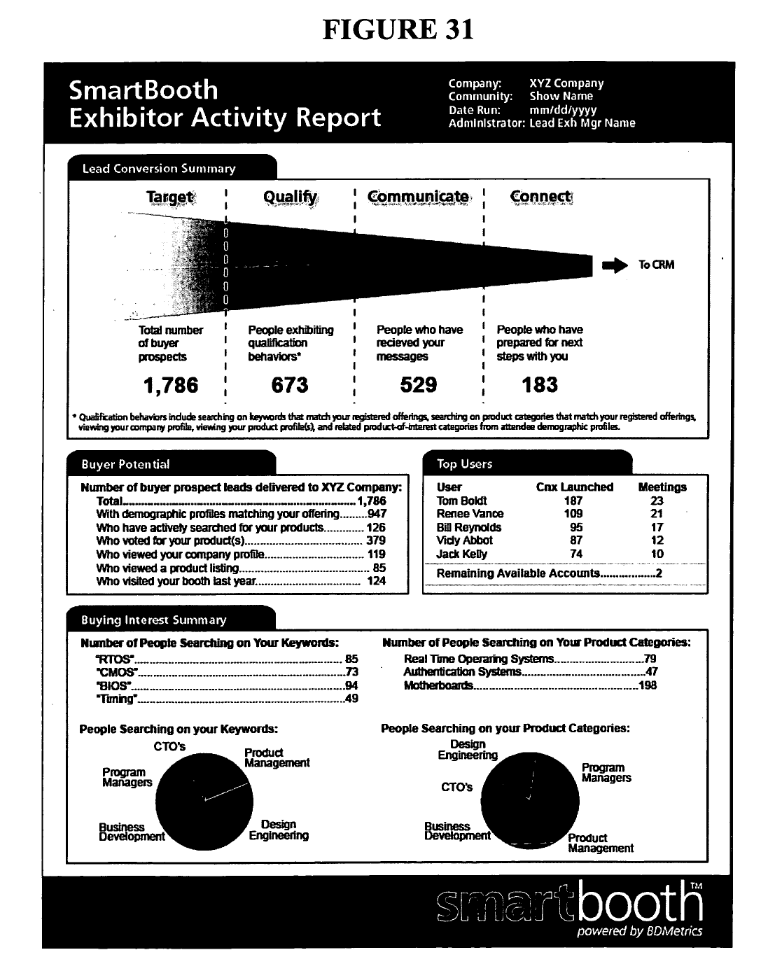

Next, the system preferably forwards a message to attendees indicating that a customized report has been prepared for each such attendee, and provides an active link which, when activated by the attendee, displays the attendee's customized “You-Based Event Report” as shown in FIG. 30. Each attendee's Event Report preferably provides a customized interface allowing each attendee a customized program experience to maximize their own return on investment and realization of opportunities in establishing connections with potential partners. As shown in FIG. 30, the Event Report preferably particularly provides the user a number of active links to display people, product, and information that has been customized for the particular attendee. Such lists preferably include: (i) a listing of contacts that share the attendee's job function and areas of expertise; (ii) a listing of keywords used in high frequency by persons having similar User Profiles to the particular attendee's; (iii) a listing of product and services available from other users that match the attendee's Product Interest data element in their User Profile; (iv) a listing of sessions available whose subject matter relates to the attendee's job responsibilities, products, and product offerings data elements in their User Profile; and (v) a listing of other users who have indicated Product Interests in their User Profiles that relate to the attendee's own Product Interests.

The next message sent by the system is preferably a message directed to exhibitors indicating a number of additional attendee contacts of potential value for the specific exhibitor. Such list is preferably compiled by distributing additional leads in that exhibitor's lead list to the specific exhibitor. Such list again enables the exhibitor receiving the message to engage the connections function described above with each attendee on such list, the contacts being initially treated as pending connections.

Next, the system preferably directs a message to exhibitors with a link which, when activated, presents the exhibitor with an Exhibitor Activity Report as shown in FIG. 3 1. The Exhibitor Activity Report preferably provides a summary of the lead conversion process for the specific exhibitor, providing (as detailed above) the numbers of target leads, qualified leads, leads with whom a connection has been sought, and leads with whom a connection has been established. Additional the Exhibitor Activity Report preferably provides the exhibitor a listing of the total numbers of prospective business partners having matching criteria in their User Profiles or who have practiced behaviors which have relation to the criteria in the exhibitor's own User Profile. For example, such categories of prospective business partners may include users having demographic profiles matching the exhibitor's product offerings, users who have searched for the exhibitor's products, users who have voted for the exhibitor's product(s) (e.g., in a “best of show” vote for best product), users who have viewed the exhibitor's company profile, users who have viewed a product listing of the exhibitor, and users who visited the exhibitor's booth in prior programs, e.g., prior tradeshows. Additionally, the Exhibitor Activity Report preferably provides a summary of interests of prospective business partners in the exhibitor's products or services. More particularly, the Exhibitor Activity Report preferably reflects numbers of other users who have conducted searches on keywords associated with the exhibitor's products or services in the exhibitor's User Profile, the job functions of such persons, the number of other users who have conducted searches on product categories associated with the exhibitor's products or services in the exhibitor's User Profile, and the job functions of such persons.

Lastly, following the program, a message is preferably directed to both attendees and exhibitors as a follow up. For attendees, such message preferably provides a listing of exhibitors on whose lead list such attendee is listed, but with whom such attendee did not establish contact or a connection through the program. For exhibitors, such message preferably provides an indication of the number of additional leads on the exhibitor's lead list with whom the exhibitor did not establish contact or a connection through the program. Such message preferably provides the exhibitor opportunity to further engage the system to identify at least a portion of those leads and engage the above-described connection function to further pursue a potential connection with such users.

Again, the above series of messages are preferably temporally dispersed. For instance, the first message might be forwarded to the exhibitor 60 days before the program which will draw together the relevant population, and the messages that follow may be separated by, for example, 1-5 days between each such message, in order to provide continual interaction with exhibitors and attendees far beyond the program experience itself. Also, it should be noted that the particularly ordering of the messages noted above is not critical and may be modified without departing from the spirit and scope of the invention. Likewise, while the steps above for transmitting messages to both attendees and exhibitors are presented as being interspersed for convenience, it is noted that each should be viewed separately as a series of temporally disparate messages directed to exhibitors and temporally disparate messages directed to attendees.

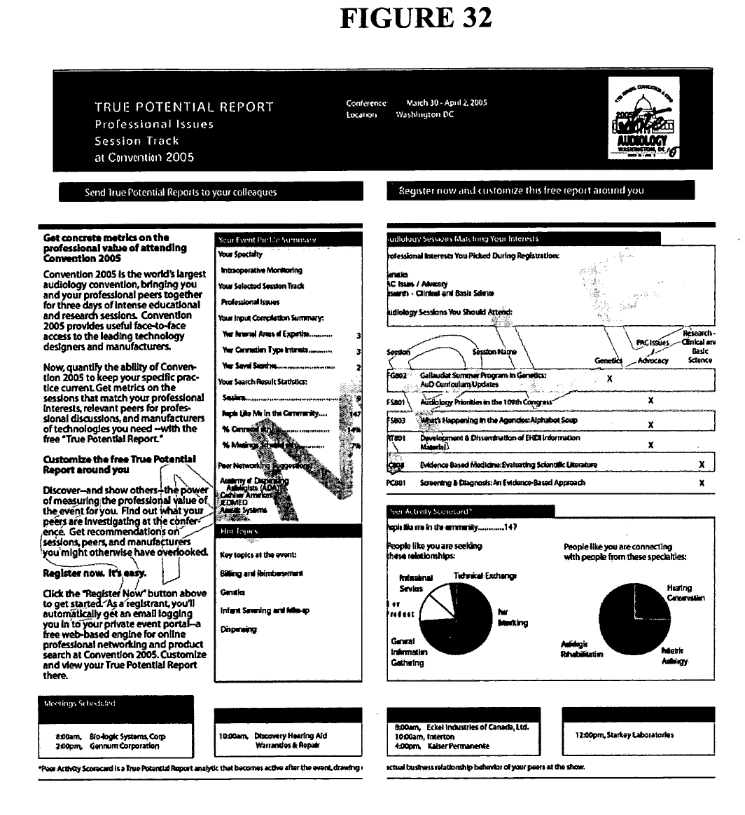

In addition to the reports referenced above, the system also preferably provides, at some point in advance of the program that will bring together the relevant population, Justification Reports (an example of which is shown in FIG. 32) directed to attendees and exhibitors that provide metrics highlighting the value of exhibiting and/or attending the program. Such reports are preferably focused on revealing the specific opportunity available at the program for individual attendee's and exhibitor's goals, in order to provide specific, objective justification for program participation. The metrics provided on such report are preferably customized for the job function of the intended recipient (e.g., Executive Management, Product Management, Business Development, etc.), providing information such as numbers, types, and characteristics of potential contacts, select markets in which opportunities are available for the specific user, sessions which relate to the user's User Profile and thus that may be of interest to the user, and other data that provides a measure of the opportunities represented by participation by that user in the program. Preferably, such Justification Report is forwarded by the system to each user registered with the system, along with an active link prompting the user to forward the report to a colleague. When activated by the user, the user is presented an email contact screen on which they are prompted to input at least an email address and job function of the colleague to whom they wish to send a Justification Report, along with a Send Report function which, when activated by the user, causes a message to be sent to the system containing the sending user's email address and User ID, and at least the recipient's email address and job function. The system then generates and transmits a new report customized for the recipient's role to the recipient. Likewise, the roles of both the sender and recipient are recorded in a data record to establish that a personality link exists between such roles. This new relationship is then manually added to the relationships database with a score determined by a human analyst to estimate the overall strength of the relationship. Once added, the newly discovered relationship is used in the above-described calculations to determine overall score of a lead.

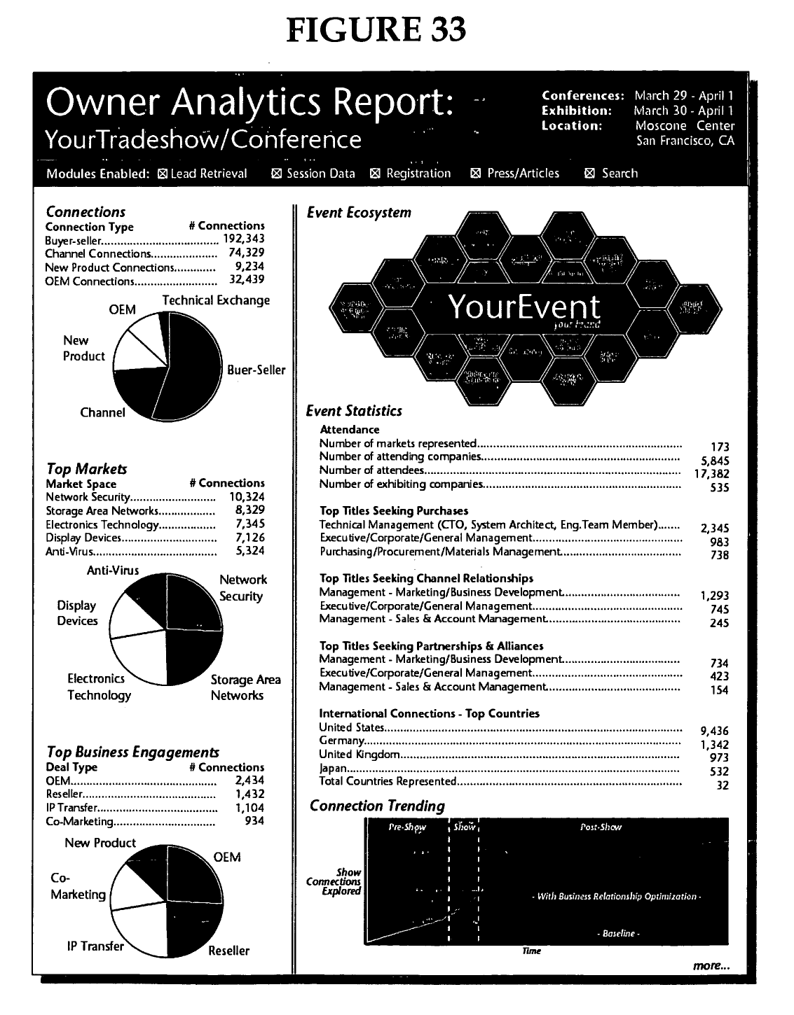

Additionally, as shown in FIG. 33, an Owner Analytics Report may likewise be generated for the program administrator providing metrics of the interactions that occurred between and among registered exhibitors and attendees. More particularly, such report preferably provides description of the connections that took place among exhibitors and registrants, the top markets in which connections took place, the types of transactions most frequently sought in the connections which took place, the market spaces represented by the registered exhibitors and attendees, and a number of additional statistics allowing the program administrator to gauge the types of persons who registered for the program, and thus the types of persons that should be targeted for registration for future programs.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A system for the determination and reporting of business development opportunities, comprising:
a server computer in communication with a plurality of remote user computers configured for the exchange of data there between, said server computer having executable computer code stored thereon adapted to:
(a) receive user profile data from remote users, said user profile data comprising demographic data relating to said user, a business entity with which said user is affiliated, and products and/or services with which said business entity is affiliated;
(b) record behavior data relating to behaviors exercised by said remote users; and
(c) identify leads for a first user having a first user profile based on lead criteria in said first user profile, said leads comprising at least a portion of user data from other users whose user data matches at least a portion of said lead criteria of said first user.
